(19) United States
(12) Patent Application Publication
(10) Pub. No.: US 2026/0130435 A1
(43) Pub. Date: May 14, 2026

(54) AN ADAPTABLE AEROSOL-GENERATING SYSTEM AND METHOD

(71) Applicant: Philip Morris Products S.A., Neuchatel (CH)

(72) Inventor: Rui Nuno Rodrigues Alves BATISTA, Morges (CH)

(73) Assignee: Philip Morris Products S.A., Neuchatel (CH)

(21) Appl. No.: 19/120,465

(22) PCT Filed: Oct. 18, 2023
(86) PCT No.: PCT/EP2023/078959

§ 371 Date: Apr. 11, 2025

(30) Foreign Application Priority Data
Oct. 19, 2022 (EP) 22202616.3

(51) Int. Cl. A24F 40/51; A24F 40/57; A24F 40/65; G01N 29/04

(52) U.S. Cl. CPC A24F 40/51; A24F 40/57; A24F 40/65; G01N 29/04; G01N 2291/02845

(57) ABSTRACT

An aerosol-generating device for generating aerosol from an aerosol-generating article is provided, the aerosol-generating device including: at least one sensor configured to determine a humidity of the aerosol-generating article; and a controller configured to control at least one function of a plurality of control functions of the aerosol-generating device based on the humidity of the aerosol-generating article determined by the at least one sensor, the at least one sensor including at least one acoustic sensor. An aerosol-generating system including the aerosol-generating device the aerosol-generating article is also provided. A method of operating an aerosol-generating system is also provided.

The present disclosure relates to an aerosol-generating system; a method of operation for an aerosol-generating system; and an aerosol-generating device.

Aerosol-generating systems configured to generate inhalable aerosol from an aerosol-forming substrate are known in the art. Some prior aerosol-generating systems comprise an aerosol-generating-device that is couplable to an aerosol-generating article. A typical aerosol-generating article for use with an aerosol-generating device comprises an aerosol-forming substrate, and a typical aerosol-generating-device comprises a heater assembly comprising a heating element, the heating element configured to heat the aerosol-forming substrate.

Typically, in such heated smoking articles an aerosol is generated by the transfer of heat from a heat source to a physically separate aerosol-generating substrate or material, which may be located in contact with, within, around, or downstream of the heat source. During use of the aerosol-generating article, volatile compounds are released from the aerosol-generating substrate by heat transfer from the heat source and are entrained in air drawn through the aerosol-generating article. As the released compounds cool, they condense to form an aerosol. The aerosol may then be inhaled by a user.

However, operational requirements and environments for such typical aerosol-generating systems vary worldwide. It would be advantageous to provide an aerosol-generating system which is adaptable to the environment or geographical requirements in which it is used, such that the same aerosol-generating system may be used by users worldwide. For example, high humidity in the environment can cause high humidity of the aerosol-generating article itself. High humidity of the aerosol-generating article can then cause a so called ‘hot aerosol’ problem, in which aerosol of an undesirably high temperature is delivered to a user. It would therefore be desirable to minimise the ‘hot aerosol’ problem when the aerosol-generating system is used in high humidity environments.

According to a first aspect of the present disclosure, there is provided an aerosol-generating system. The aerosol-generating system may comprise an aerosol-generating device. The aerosol-generating system may comprise an external computing device separate from the aerosol-generating device. The aerosol-generating system may comprise a location determining apparatus. In particular, the external computing device may comprise the location determining apparatus. The location determining apparatus may be configured to determine a location of the aerosol-generating system. The location determining apparatus may be configured to output location data indicative of (or dependent on) the location of the aerosol-generating system. The aerosol-generating system may comprise a controller. The controller may be configured to control a plurality of control functions of the aerosol-generating system. The plurality of control functions of the aerosol-generating system may be a plurality of control functions of the aerosol-generating device. That is, the controller may be configurable to perform the plurality of control functions for controlling the aerosol-generating device. The aerosol-generating system may be configured to adjust the control of at least one of the plurality of control functions based on the location of the aerosol-generating system determined by the location determining apparatus. The aerosol-generating system may be configured to select at least one of the plurality of control functions based on the location data. The external computing device may be configured to cause the controller to be configured to perform the selected control functions.

Advantageously, the aerosol-generating system may therefore be adaptable to the local environment in which the aerosol-generating system is used. For example, if it is determined that the aerosol-generating system is located in a region of high humidity, or where high humidity is common, the functions of the aerosol-generating system can be adjusted accordingly. When these functions include heating of an aerosol-forming substrate, such that the heating of the aerosol-forming substrate may be adjusted, minimising the likelihood of hot aerosol, as described above, which may be otherwise supplied to the user. The same aerosol-generating system may therefore be used in different environments, without the user experiencing different aerosol effects arising as a result of the location of the aerosol-generating system.

The external computing device may be a personal computing device. Preferably, the personal computing device is a smartphone. The external computing device may be configured to communicate with the aerosol-generating device using a communications interface. The communications interface may be a wireless communications interface. The wireless communications interface may be one or both of Bluetooth or Wi-Fi. Advantageously, personal communications devices, such as smartphones, often comprise wireless communications interfaces with well-known standards, such as Bluetooth or Wi-Fi. The communications interface may be a wired communications interface. The wired communications interface may be a USB connection.

The plurality of control functions may be a predefined set of control functions.

The external computing device may be configured to send data derived from the location data to the controller. The external computing device may be configured to send the location data or data derived from the location data to the controller. In particular, the external computing device being configured to cause the controller to be configured to perform the selected control functions may comprise the external computing device being configured to send the location data or data derived from the location data to the controller. The external computing device may be configured to wirelessly send the location data or data derived from the location data to the controller. Advantageously, if the external computing device is a personal computing device, such as a smartphone, the complexity of manufacturing the aerosol-generating device may therefore be reduced. Smartphones already comprise location determining apparatus, so further location determining apparatus is not required to be contained within the aerosol-generating device.

The data derived from the location data may comprise firmware comprising at least one function of the plurality of control functions for controlling the aerosol-generating device, or a label derived from the location data. For instance, the location data may be in the form of GPS co-ordinates and the data derived from the location data may be a country name corresponding with the GPS co-ordinates. Advantageously, the firmware of the aerosol-generating system may therefore be adapted or updated based on the location of the aerosol-generating system.

The location determining apparatus may comprise a global positioning system (GPS) chip, or any other satellite navigation chip. The location determining apparatus may determine the location data based on data output from the GPS chip. Advantageously, using a GPS chip may provide an automatic, reliable and accurate indicator of the location of the aerosol-generating system, without requiring input from a user.

The external computing device may comprise a memory storing data indictive of the location of the external computing device. The memory may store an IP address of the external computing device. The location determining apparatus may determine the location data from data stored in the memory of the external computing device. The location determining apparatus may determine the location data from the IP address of the external computing device. Advantageously, using an IP address may provide an automatic, reliable and accurate indicator of the location of the aerosol-generating system, without requiring input from a user.

The location determining apparatus may comprise a user interface for a user to input data indicative of (or dependent on) the location of the aerosol-generating system or the location of the aerosol-generating system. The location determining apparatus may determine the location data based on the location input by the user. Advantageously, a user input may be more accurate or reliable than a location of the aerosol-generating system determined by a GPS chip.

The location determining apparatus may determine the location data based on a combination of two or more of: GPS data, IP address data and/or data input by the user via a user interface. The location determining apparatus may determine the location data after confirming that at least one of the GPS data, IP address data and/or data input by the user via a user interface matches at least one of the another of the GPS data, IP address data and/or data input by the user via a user interface. Advantageously, such a system may minimise the likelihood of an incorrect determination of location of the aerosol-generating system, should one of the GPS data, IP address data and/or data input by the user be incorrect.

Selecting at least one of the plurality of control functions based on the location data may comprise the external computing device selecting a firmware version based on the location data. The external computing device being configured to cause the controller to be configured to perform the selected control functions may comprise the external computing device being configured to select a firmware version from a plurality of firmware versions available at a server. The external computing device being configured to select a firmware version from a plurality of firmware versions available at a server may comprise the external computing device being configured to send a request to the server and the external computing device being configured to receive firmware from the server for controlling the aerosol-generating device. The external computing device being configured to cause the controller to be configured to perform the selected control functions may comprise the external computing device being configured to load the selected firmware onto the aerosol-generating device. The external computing device being configured to load the selected firmware onto the aerosol-generating device may comprise the external computing device being configured to load the selected firmware onto the controller.

Advantageously, location-specific firmware may therefore be loaded onto the aerosol-generating system, in particular onto the aerosol-generating device, dependent on the location of the aerosol-generating system.

The aerosol-generating system being configured to select at least one of the plurality of control functions based on the location data may comprise the external computing device or the aerosol-generating device being configured to select one or more functions from a plurality of functions each associated with a location. The selected functions may be each associated with a location corresponding with the location data.

The plurality of control functions for controlling the aerosol-generating device may comprise at least one function for controlling an age verification process. Advantageously, as laws may vary between countries as to the age at which someone may use or purchase an aerosol-generating system or device, the aerosol-generating system may adapt its functionality regarding an age verification process in order to meet these local requirements, without substantially different aerosol-generating devices being initially required dependent on the location.

The aerosol-generating system may comprise one or more heating elements. In particular, the aerosol-generating device may comprise the one or more heating elements The aerosol-generating system may comprise a power supply for supplying power to the one or more heating elements. The controller may control the power supplied from the power supply to the one or more heating elements. The one or more heating elements may comprise a resistive or an induction heating element. The one or more hearing elements may be located in and/or around a cavity arranged to receive an aerosol-generating article. The system may comprise the aerosol-generating article, which may be for example a tobacco stick. In another example, the aerosol-generating article may be a cartridge comprising a liquid reservoir. The aerosol-generating article may comprise an aerosol forming substrate comprising nicotine.

At least one function of the plurality of control functions of the aerosol-generating system may comprise controlling the power supplied to the one or more heating elements for heating the aerosol-generating article. Advantageously, the power supplied to the one or more heating elements may be adapted to the environment in which the aerosol-generating system is located. This may result in more consistent aerosol-generation experiences for a user between locations with differing environmental conditions.

The power supply may be a rechargeable power supply. At least one function of the plurality of control functions of the aerosol-generating system may comprise controlling the power supplied to the power supply during charging. Advantageously, the charging profile supplied to the power supply may be adapted to the environment in which the aerosol-generating system is located. This may result in a more consistent charging experiences for a user between locations with differing environmental conditions. For example, different locations may have different local standards of power supply voltages or frequencies, and the typical temperatures of the different locations may affect the charging characteristics of the rechargeable power supply.

Each of the plurality of control functions may be a predetermined heating profile. A predetermined heating profile may be defined by one or more parameters, such as temperature, resistance, conductance, voltage and/or current. The one or more parameters, such as temperature, resistance, conductance, voltage and/or current may be applied at one or more stages in a heating cycle.

The selected control function may be a predetermined heating profile. The predetermined heating profile may be defined by one or more parameters, such as temperature, resistance, conductance, voltage and/or current. The one or more parameters, such as temperature, resistance, conductance, voltage and/or current may be applied at one or more stages in a heating cycle. For example, each predetermined heating profile may comprise a heating element temperature profile. The heating element temperature profile may comprise a first temperature during a first time period. The heating element temperature profile may comprise a first a second temperature during a second time period after the first time period The heating element temperature profile may comprise a first a third temperature during a third time period after the second time period. The second temperature may be lower than the first temperature. The third temperature may be greater than the second temperature.

The predetermined heating profile may further comprise a duty cycle limit having a duty cycle limit profile. The duty cycle limit may vary with time during the duty cycle limit profile. Each duty cycle limit profile may vary between each heating profile of a plurality of heating profiles.

If the location determining apparatus determines a location of the aerosol-generating system that is dry or low humidity location, the selected control function may be a dry heating profile.

If the location determining apparatus determines a location of the aerosol-generating system that is wet or high humidity location, the selected control function may be a wet heating profile.

The wet heating profile and the dry heating profile may comprise similar heating element temperature profiles. For example, the first second and third temperatures may be identical, and the first second and third time periods may differ in length by no more than 50%. The wet heating profile and the dry heating profile may comprise identical heating element temperature profiles.

The wet heating profile and the dry heating profile may comprise different duty cycle limit profiles. For example, the minimum duty cycle limit for the wet profile may be lower than the minimum duty cycle limit for the dry profile.

The duty cycle limit profile may comprise a first time portion, during which the duty cycle limit has a first value. The duty cycle limit profile may comprise a second time portion after the first time portion, during which the duty cycle limit has a second value. The duty cycle limit profile may comprise a third time portion after the second time portion, during which the duty cycle limit has a third value. The second value may be lower than the first value. The third value may be greater than the second value.

The first time period may correspond to the first time portion.

In the dry heating profile, the second time period may correspond to the second time portion. The third time period may correspond to the third time portion. In the dry heating profile, the duty cycle limit may decrease during the second time period.

In the dry heating profile, the minimum duty cycle limit may be during the second time period.

The third value in the wet heating profile may be greater than the third value in the dry heating profile. In the wet heating profile, the first time period may correspond to the first and second time portions. In the wet heating profile, the second time period may correspond to the second and third time portions. In the wet heating profile, the duty cycle limit may increase during the second time period.

In the wet heating profile, the minimum duty cycle limit may be during the first time period.

Advantageously, the (predetermined) heating profile supplied to the one or more heating elements may be adapted to the environment in which the aerosol-generating system is located. This may result in more consistent aerosol-generation experiences for a user between locations with differing environmental conditions.

The aerosol-generating system may comprise a computer readable memory. The aerosol-generating system being configured to select at least one of the plurality of control functions based on the location data comprises the aerosol-generating system being configured to select a heating profile from a plurality of heating profiles stored on the computer readable memory. The plurality of heating profiles may be a plurality of predetermined heating profiles. The aerosol-generating system being configured to select at least one of the plurality of control functions based on the location data comprises the aerosol-generating system being configured to select a power supply profile from a plurality of power supply profiles stored on the computer readable memory. The plurality of power supply profiles may be a plurality of predetermined power supply profiles. Advantageously, optimal power supply profiles for various environmental conditions in various locations may be determined and loaded on to the computer readable memory prior to the acquisition of the aerosol-generating device by a user.

The aerosol-generating system being configured to select at least one of the plurality of control functions based on the location data comprises the aerosol-generating system being configured to select an age verification processes from a plurality of an age verification processes stored on the computer readable memory. Advantageously, suitable age verification processes for various locations may be determined and loaded on to the computer readable memory prior to the acquisition of the aerosol-generating device by a user.

The aerosol-generating system may be configured to generate an aerosol comprising nicotine. The aerosol-generating system further comprise an aerosol-generating article. The aerosol-generating article may comprise an aerosol-generating substrate comprising nicotine.

According to a second aspect of the disclosure there is provided a method of controlling an aerosol-generating system. The aerosol generating system may be any aerosol-generating system according to the first aspect of the disclosure. The aerosol-generating system may comprise an aerosol-generating device and an external computing device separate from the aerosol-generating device. The external computing device may comprise a location determining apparatus configured to output location data indicative of (or dependent on) the location of the aerosol-generating system.

The method may comprise the step of determining a location of the aerosol-generating system. The step of determining the location of the aerosol-generating system may comprise the external computing device determining a location of the aerosol-generating system.

The method may comprise the step of the external computing device outputting location data indicative of (or dependent on) the location of the aerosol-generating system.

The method may comprise the step of adjusting the control of at least one function of a plurality of control functions of the aerosol-generating system based on the location of the aerosol-generating system determined by the aerosol-generating system.

The method may comprise the step of the aerosol-generating system selecting at least one of the plurality of control functions based on the location data.

The method may comprise the step of the external computing device causing the controller to be configured to perform the selected control functions.

Advantageously, the method of controlling the aerosol-generating system may therefore be adaptable to the local environment in which the aerosol-generating system is used. For example, if it is determined that the aerosol-generating system is located in a region of high humidity, or where high humidity is common, the functions of the aerosol-generating system can be adjusted accordingly. When these functions include heating of an aerosol-forming substrate, such that the heating of the aerosol-forming substrate may be adjusted, minimising the likelihood of hot aerosol, as described above, which may be otherwise supplied to the user. The same aerosol-generating system may therefore be used in different environments, with minimal change in experience without for the user experiencing different aerosol effects arising as a result of the location of the aerosol-generating system. The aerosol-generating system may comprise an aerosol-generating device. The step of adjusting the control of the at least one function of the plurality of control functions of the aerosol-generating system based on the location of the aerosol-generating system may comprise adjusting the control of the at least one function of a plurality of control functions of the aerosol-generating device based on the location of the aerosol-generating system.

The location determining apparatus may comprise a user interface for a user to input data indicative of the location of the aerosol-generating system or the location of the aerosol-generating system. The step of determining the location of the aerosol-generating system may comprise the user inputting data indicative of the location of the aerosol-generating system or the location of the aerosol-generating system using the interface.

The step of determining the location of the aerosol-generating system may comprise using a global positioning system (GPS) chip, or any other satellite navigation chip. The step of determining the location of the aerosol-generating system may comprise data output from the GPS chip.

The location determining apparatus may comprise memory storing data indictive of the location of the external computing device. The location determining apparatus may comprise memory storing the IP address of the external computing device. The step of determining the location of the aerosol-generating system may comprise using data stored in the memory of the external computing device. Using data stored in the memory of the external computing device may comprise using the IP address of the external computing device. In other words, the step of determining the location of the aerosol-generating system may comprise using the IP address of the external computing device.

The step of determining the location of the aerosol-generating system may be based on a combination of two or more of: GPS data, IP address data and/or data input by the user via a user interface. The step of determining the location of the aerosol-generating system may comprise confirming that at least one of the GPS data, IP address data and/or data input by the user via a user interface matches at least one of the another of the GPS data, IP address data and/or data input by the user via a user interface.

The step of causing the controller to be configured to perform the selected control functions may comprise the external computing device sending the data derived from the location of the aerosol-generating system to the aerosol-generating device. The step of causing the controller to be configured to perform the selected control functions may comprise the external computing device sending the location data or data derived from the location of the aerosol-generating system to the aerosol-generating device.

The step of causing the controller to be configured to perform the selected control functions may comprise the external computing device wirelessly sending the location data or data derived from the location of the aerosol-generating system to the aerosol-generating device.

The data derived from the location data may comprise firmware for causing the controller to be configured to perform the selected control function.

The step of the aerosol-generating system selecting at least one of a plurality of control functions based on the location data may comprise the external computing device sending firmware to the aerosol-generating device.

The step of the aerosol-generating system selecting at least one of a plurality of control functions based on the location data may comprise the aerosol-generating system sending a request to a server and the aerosol-generating system receiving firmware from the server for causing the controller to be configured to perform the selected control function.

The aerosol-generating system receiving firmware from the server for causing the controller to be configured to perform the selected control functions may comprise the controller receiving firmware from the server for causing the controller to be configured to perform the selected control function.

The aerosol-generating system may comprise a power supply for supplying power to one or more heating elements, wherein the controller controls the power supplied from the power supply to the one or more heating elements.

The aerosol-generating system may comprise the one or more heating elements. Preferably, the aerosol-generating device comprises the one or more heating elements. The step of causing the controller to be configured to perform the selected control functions may comprise causing the controller to be configured to control the power supplied to the one or more heating elements for heating the aerosol-generating article. The one or more heating elements may comprise a resistive or an induction heating element. The one or more hearing elements may be located in and/or around a cavity arranged to receive an aerosol-generating article. The system may comprise the aerosol-generating article, which may be for example a tobacco stick. In another example, the aerosol-generating article may be a cartridge comprising a liquid reservoir. The aerosol-generating article may comprise an aerosol forming substrate comprising nicotine.

Each of the plurality of control functions may be a predetermined heating profile. The predetermined heating profile may be defined by one or more parameters, such as temperature, resistance, conductance, voltage and/or current. The one or more parameters, such as temperature, resistance, conductance, voltage and/or current may be applied at one or more stages in a heating cycle.

The selected control function may be a predetermined heating profile. The predetermined heating profile is defined by one or more parameters, such as temperature, resistance, conductance, voltage and/or current. The one or more parameters, such as temperature, resistance, conductance, voltage and/or current may be applied at one or more stages in a heating cycle.

The power supply may be a rechargeable power supply. The step of causing the controller to be configured to perform the selected control functions may comprise causing the controller to be configured to control the power supplied to the power supply during charging.

The step of causing the controller to be configured to perform the selected control functions may comprise causing the controller to be configured to control an age verification process.

The aerosol-generating system may comprise a computer readable memory. The step of controlling at least one function of the plurality of control functions of the aerosol-generating system based on the location of the aerosol-generating system may comprise selecting a heating profile from a plurality of heating profiles stored on the computer readable memory.

The step of causing the controller to be configured to perform the selected control functions may comprise selecting a power supply profile from a plurality of power supply profiles stored on the computer readable memory.

The step of causing the controller to be configured to perform the selected control functions may comprise selecting an age verification process from a plurality of age verification process stored on the computer readable memory.

According to a third aspect of the present disclosure, there is provided an aerosol-generating device. The aerosol-generating device may be the aerosol-generating device described in accordance with the first or second aspects of the disclosure. The aerosol-generating device may comprise a controller. The controller may be configured to receive data indicative of (or dependent on) a location of the aerosol-generating device. The controller may be configured to control at least one function of a plurality of control functions of the aerosol-generating device. The control of the at least one function of the plurality of control functions may be adjusted based on the data indicative of (or dependent on) the location of the aerosol-generating device received by the controller. The controller may be configured to select at least one control function of the aerosol-generating device from a plurality of control functions for the aerosol-generating device based on the data indicative of (or dependent on) the location of the aerosol-generating device received by the controller. The controller may be configured to control the aerosol-generating device using the selected control function.

Advantageously, the aerosol-generating device may therefore be adaptable to the local environment in which the aerosol-generating device is used. For example, if it is determined that the aerosol-generating device is located in a region of high humidity, or where high humidity is common, the functions of the aerosol-generating system can be adjusted accordingly. When these functions include heating of an aerosol-forming substrate, such that the heating of the aerosol-forming substrate may be adjusted, minimising the likelihood of hot aerosol, as described above, which may be otherwise supplied to the user. The same aerosol-generating device may therefore be used in different environments, with minimal change in experience without for the user experiencing different aerosol effects arising as a result of the location of the aerosol-generating device. The controller may be configured to receive data indicative of (or dependent on) the location of the aerosol-generating device from an external computing device configured to communicate with the aerosol-generating device.

The controller may be configured to communicate with the external computing device. The controller may be configured to receive data indicative of (or dependent on) the location of the aerosol-generating system from the external computing device.

The controller may be configured to wirelessly communicate with the external computing device. The external computing device may be a personal computing device. The controller may be configured to wirelessly receive data indicative of (or dependent on) the location of the aerosol-generating device from the external computing device. The data indicative of (or dependent on) the location of the aerosol-generating system may comprise firmware comprising at least one function of the plurality of control functions for controlling the aerosol-generating device.

The aerosol-generating device may comprise device location determining apparatus. The device location determining apparatus may be configured to send data indicative of (or dependent on) the location of the aerosol-generating device to the controller. Advantageously, if the aerosol-generating device itself comprises device location determining apparatus, an external computing device may not be required to determine the location of the aerosol-generating device.

The device location determining apparatus may comprise a global positioning system (GPS) chip, or any other satellite navigation chip. The device location determining apparatus may determine the location data based on data output from the GPS chip. The device location determining apparatus may comprise memory storing data indictive of the location of the device. The data indictive of the location of the device may comprise an IP address of an external computing device. The device location determining apparatus may determine the location data from data indictive of the location of the device stored in the memory of the aerosol-generating device. The device location determining apparatus may determine the location data from the IP address of the external computing device. The device location determining apparatus may comprise a user interface for a user to input data indicative of the location of the aerosol-generating system or the location of the aerosol-generating system. The device location determining apparatus may determine the location data based on the location input by the user.

The device location determining apparatus may determine the location data based on a combination of two or more of: GPS data, IP address data and/or data input by the user via a user interface. The device location determining apparatus may determine the location data after confirming that at least one of the GPS data, IP address data and/or data input by the user via a user interface matches at least one of the another of the GPS data, IP address data and/or data input by the user via the user interface.

The controller may be configured to receive firmware from a server, the firmware indicative of (or dependent on) the location of the aerosol-generating device. The firmware may be for controlling at least one function of the plurality of control functions of the aerosol-generating device.

The aerosol-generating device may comprise a power supply for supplying power to one or more heating elements, wherein the controller controls the power supplied from the power supply to the one or more heating elements.

The aerosol-generating device may comprise one or more heating elements. At least one function of the plurality of control functions of the aerosol-generating device may comprise controlling the power supplied to the one or more heating elements for heating the aerosol-generating article. The one or more heating elements may comprise a resistive or an induction heating element. The one or more hearing elements may be located in and/or around a cavity arranged to receive an aerosol-generating article. The system may comprise the aerosol-generating article, which may be for example a tobacco stick. In another example, the aerosol-generating article may be a cartridge comprising a liquid reservoir. The aerosol-generating article may comprise an aerosol forming substrate comprising nicotine.

Each of the plurality of control functions may be a predetermined heating profile. The predetermined heating profile may be defined by one or more parameters, such as temperature, resistance, conductance, voltage and/or current. The one or more parameters, such as temperature, resistance, conductance, voltage and/or current may be applied at one or more stages in a heating cycle.

The selected control function may be a predetermined heating profile. The predetermined heating profile is defined by one or more parameters, such as temperature, resistance, conductance, voltage and/or current. The one or more parameters, such as temperature, resistance, conductance, voltage and/or current may be applied at one or more stages in a heating cycle.

The power supply may be a rechargeable power supply. The at least one function of the plurality of control functions of the aerosol-generating device may comprise controlling the power supplied to the power supply during charging.

The at least one function of the plurality of control functions of the aerosol-generating device may comprise controlling an age verification process.

The aerosol-generating device may comprise a computer readable memory. The at least one function of the plurality of control functions of the aerosol-generating device may comprise selecting a heating profile from a plurality of heating profiles stored on the computer readable memory. The at least one function of the plurality of control functions of the aerosol-generating device may comprise selecting a power supply profile from a plurality of power supply profiles stored on the computer readable memory.

The power supply may be a rechargeable power supply. The at least one function of the plurality of control functions of the aerosol-generating device may comprise selecting an age verification process from a plurality of age verification processes stored on the computer readable memory.

The aerosol-generating device may be configured to generate an aerosol comprising nicotine.

According to a fourth aspect of the disclosure, there is provided an aerosol-generating device. The aerosol-generating device may be for generating aerosol from an aerosol-generating article. The aerosol-generating device may comprise at least one sensor configured to determine a humidity of the aerosol-generating article. The aerosol-generating device may comprise a controller configured to control at least one function of a plurality of control functions of the aerosol-generating device based on the humidity of the aerosol-generating article determined by the at least one sensor.

Advantageously, the aerosol-generating device therefore adjusts its operation dependent on the detected humidity of the aerosol-generating article, so that optimal aerosol generation may be achieved by the aerosol-generating device. The humidity detected by a sensor may more accurately reflect the true humidity of an aerosol-generating article compared to using a local humidity of a location of the aerosol-generating device.

The aerosol-generating device may comprise a cavity for receiving an aerosol-generating article. The aerosol-generating device may be configured to be coupled to an aerosol-generating article. The at least one sensor may be configured to determine a humidity of the aerosol-generating article when the aerosol-generating article is received in the cavity. The at least one sensor may be configured to determine a humidity of the aerosol-generating article when the aerosol-generating article is coupled to the aerosol-generating device.

The aerosol-generating device may comprise one or more heating elements. The one or more heating elements may be configured to heat the aerosol-generating article.

The aerosol-generating device may comprise a power supply. The controller may be configured to control a supply of power from the power supply to the one or more heating elements. The one or more heating elements may comprise a resistive or an induction heating element. The one or more hearing elements may be located in and/or around a cavity arranged to receive an aerosol-generating article. The system may comprise the aerosol-generating article, which may be for example a tobacco stick. In another example, the aerosol-generating article may be a cartridge comprising a liquid reservoir. The aerosol-generating article may comprise an aerosol forming substrate comprising nicotine.

The aerosol-generating device may be couplable to an aerosol-generating article comprising one or more heating elements. The controller may configured to control a supply of power from the power supply to the one or more heating elements.

The at least one function of the plurality of control functions of the aerosol-generating device may comprise controlling the supply of power supplied to one or more heating elements. controlling the supply of power supplied to the heating element may comprise controlling a heating profile of the one or more heating elements. Advantageously, the heating of the aerosol-generating article by the aerosol-generating device is adjusted dependent on the detected humidity of the aerosol-generating article. Advantageously, this may minimise or reduce the likelihood of a ‘hot-aerosol’ experience for the user.

The aerosol-generating device may comprise a computer readable memory. The controller may be configured to select a heating profile stored in the readable computer memory based on the humidity of the aerosol-generating article. The controller may be configured to select a heating profile stored in the readable computer memory from a plurality of heating profiles based on the humidity of the aerosol-generating article.

The at least one function of the plurality of control functions of the aerosol-generating device may comprise stopping the power supplied to one or more heating elements. Advantageously, the power supplied to the one or more heating elements may be stopped, for example if the humidity of the aerosol-generating article is too high to generate an acceptable aerosol to be delivered to the user, such as an aerosol which is too hot.

The at least one function of the plurality of control functions of the aerosol-generating device may comprise displaying a warning to a user. Advantageously, a warning may be displayed to a user, for example if the humidity of the aerosol-generating article is too high to generate an acceptable aerosol to be delivered to the user, such as an aerosol which is too hot.

The at least one function of the plurality of control functions of the aerosol-generating device may comprise displaying a suggestion for at least one user setting of the aerosol-generating device to a user. Advantageously, a suggestion for a setting may be displayed to a user, for example if the humidity of the aerosol-generating article is too high to generate an acceptable aerosol in a first mode, the device may suggest to the user to switch the device into a second mode in which an acceptable aerosol may be generated using the device.

The at least one sensor may comprise at least one acoustic sensor.

The acoustic sensor may comprise at least one acoustic transceiver. The at least one acoustic transceiver may be configured to emit sound waves with at least one frequency and receive the sound waves with the at least one frequency.

The at least one acoustic sensor may comprise at least one acoustic emitter configured to emit sound waves with at least one frequency and at least one acoustic receiver configured to receive the sound waves with the at least one frequency.

Advantageously, the at least one acoustic sensor may determine the humidity of the entire cross-section of the aerosol-generating article, as the sound waves may pass through the aerosol-generating article.

The at least one acoustic emitter may comprise a first acoustic emitter positioned adjacent to the cavity. The at least one acoustic receiver may comprise a first acoustic receiver positioned adjacent to the cavity.

The sound waves emitted by the first acoustic emitter and received by the first acoustic receiver may propagate through the aerosol-generating article when the aerosol-generating article is received in the cavity. The sound waves emitted by the first acoustic emitter and received by the first acoustic receiver may propagate through the aerosol-generating article when the aerosol-generating article is coupled to the aerosol-generating device.

The cavity may comprise a proximal end located at the opening of the cavity and a distal end located at an opposite end of the cavity to the proximal end. The cavity may comprise a heating zone located between the distal end and the proximal end.

The heating zone may not extend to the distal end. The heating zone may not extend to the proximal end. Advantageously if the heating zone does not extend to the proximal end or the distal end, this may protect components at the distal end of the cavity, and the user at the proximal end of the cavity from excess heat. For example the user's fingers when inserting or withdrawing an aerosol-generating article from the cavity are distanced from the heating zone.

The first acoustic receiver and the first acoustic emitter may be positioned outside of the heating zone. Advantageously in this way, damage to the first acoustic receiver and the first acoustic emitter by excessive heat may be minimised. The first acoustic transceiver may be positioned outside of the heating zone. Advantageously in this way, damage to the first acoustic transceiver by excessive heat may be minimised.

The first acoustic receiver and the first acoustic emitter may be positioned on opposite sides of the heating zone to one another, such that the sound waves emitted by the first acoustic emitter and received by the first acoustic receiver propagate through the aerosol-generating article when the aerosol-generating article is received in the cavity. Advantageously, the sound waves emitted by the first acoustic emitter and received by the first acoustic receiver propagate through a portion of the aerosol-generating article configured to be heated. This may be the portion of the aerosol-generating article where humidity of the aerosol-generating article has the greatest effect on aerosol-generation. The first acoustic receiver may be positioned at the proximal end of the cavity and the first acoustic emitter may be positioned at the distal end of the cavity.

The at least one acoustic emitter may comprise a second acoustic emitter.

The first acoustic emitter and the second acoustic emitter may be positioned on opposite sides of the heating zone to one another.

The first acoustic emitter may be positioned at the distal end of the cavity and the second acoustic emitter may be positioned at the proximal end of the cavity.

The first acoustic emitter and the second acoustic emitter may be positioned such that the sound waves emitted from the first acoustic emitter may be configured to propagate through a first portion of the aerosol-generating article when the aerosol-generating article is received in the cavity, and the sound waves emitted from the second acoustic emitter may be configured to propagate through a second portion of the aerosol-generating article when the aerosol-generating article is received in the cavity. Advantageously, the humidity of the aerosol-generating article may be more accurately determined when two portions of the aerosol-generating article are sensed using the first and second acoustic emitters. Also advantageously, the classification of the aerosol-generating article, as described in more detail below, may be more accurately determined when sound waves from the first and second acoustic emitters propagate through two different portions of the aerosol-generating article.

The at least one acoustic receiver further may comprise a second acoustic receiver.

The first acoustic receiver and the second acoustic receiver may be positioned on opposite sides of the heating zone to one another. The first acoustic receiver may be positioned at the distal end of the cavity. The second acoustic receiver may be positioned at the proximal end of the cavity. The first acoustic receiver and the second acoustic receiver may be positioned such that the sound waves received by the first acoustic receiver are configured to propagate through a first portion of the aerosol-generating article when the aerosol-generating article is received in the cavity, and the sound waves received by the second acoustic receiver are configured to propagate through a second portion of the aerosol-generating article when the aerosol-generating article is received in the cavity.

The first acoustic receiver and the first acoustic emitter may be positioned on the same side of the heating zone as one another. The first acoustic emitter may be configured to emit sound waves which propagate through the heating zone to the distal end of the cavity, and propagate back from the distal end of the cavity through the heating zone to the first acoustic receiver. The first acoustic transceiver may be configured to emit sound waves which propagate through the heating zone to the distal end of the cavity, and propagate back from the distal end of the cavity through the heating zone to the first acoustic transceiver. Advantageously, the at least one sensors being located on only one side of the heating zone may simplify manufacturing, for example by reducing the space used in the device by the at least one sensors and corresponding controller. Also advantageously, as the sound waves propagate through the heating zone to the distal end of the cavity and propagate back from the distal end of the cavity through the heating zone may pass through more of the aerosol-generating article, such that the humidity or classification of the aerosol-generating article is more accurately determined.

The at least one frequency may comprise a plurality of different frequencies. Advantageously, using a plurality of different frequencies may more accurately determine the humidity or classification of the aerosol-generating article, as the damping experienced by the sound waves may vary depending on the frequency of the sound waves.

The at least one frequency may comprise an ultrasound frequency. The at least one frequency may comprise a frequency greater that 20 kilohertz.

The aerosol-generating device may be configured to determine the location of the aerosol-generating device or receive data indicative of (or dependent on) a location of the aerosol-generating device.

The controller may be configured to control at least one function of the plurality of control functions of the aerosol-generating device based on the location of the aerosol-generating device or the data indicative of (or dependent on) the location of the aerosol-generating device. The controller may be configured to control at least one function of the plurality of control functions of the aerosol-generating device based on a combination of the location of the aerosol-generating device or the data indicative of (or dependent on) the location of the aerosol-generating device, and the humidity of the aerosol-generating article. Advantageously, the operation of the aerosol-generating device may be better adapted to both the environment in which it is located as well as the humidity of the aerosol-generating article. This may result in a better user experience, for example, when heating the aerosol-generating article to generate aerosol.

The aerosol-generating device may comprise a device location determining apparatus, the device location determining apparatus configured to determine the location of the aerosol-generating device.

According to a fifth aspect of the disclosure, there is provided an aerosol-generating system. The aerosol-generating system may comprise an aerosol-generating device according to the fourth aspect of the disclosure. The aerosol-generating system may comprise an external computing device. The external computing device may be connected to the aerosol-generating device. The external computing device may be in communication with to the aerosol-generating device. The aerosol-generating device may comprise the controller. The external computing device may comprise a system location determining apparatus. The system location determining apparatus may be configured to output location data indicative of (or dependent on) the location of the aerosol-generating system. Advantageously, a system location determining apparatus in an external computing device may determine the location of the aerosol-generating system more accurately than a device location determining apparatus.

The external computing device may be configured to send the location data indicative of (or dependent on) the location of the aerosol-generating system or the location of the aerosol-generating system to the controller.

The system location determining apparatus may comprise a user interface for a user to input data indicative of the location of the aerosol-generating system or the location of the aerosol-generating system. Advantageously, a user input of data indicative of the location of the aerosol-generating system or the location of the aerosol-generating system may be more accurate than using, for example, a GPS chip.

The system location determining apparatus may comprise a global positioning system (GPS) chip, or any other satellite navigation chip. The system location determining apparatus may determine the location data based on data output from the GPS chip. Advantageously, using a GPS chip eliminates the need for the aerosol-generating device to have hardware and a user interface suitable for a user to input data indicative of the location of the aerosol-generating system or the location of the aerosol-generating system.

The system location determining apparatus may comprise memory storing data indictive of the location of the external computing device. The data indictive of the location of the external computing device may comprise the IP address of the external computing device. The system location determining apparatus may determine the location data from data stored in the memory of the external computing device. The system location determining apparatus may determine the location data from the IP address of the external computing device Advantageously, using a stored IP address eliminates the need for the aerosol-generating device to have hardware and a user interface suitable for a user to input data indicative of the location of the aerosol-generating system or the location of the aerosol-generating system.

The system location determining apparatus may determine the location data based on a combination of two or more of: GPS data, IP address data and/or data input by the user via a user interface. The system location determining apparatus may determine the location data after confirming that at least one of the GPS data, IP address data and/or data input by the user via a user interface matches at least one of the another of the GPS data, IP address data and/or data input by the user via a user interface. Advantageously, such a system may minimise the likelihood of an incorrect determination of location of the aerosol-generating system, should one of the GPS data, IP address data and/or data input by the user be incorrect.

The data indicative of (or dependent on) the location of the aerosol-generating system may comprise a local humidity of the location of the aerosol-generating system. The local humidity of the location of the aerosol-generating system may be an ambient humidity determined by the external computing device using humidity data from a weather server. The local humidity of the location of the aerosol-generating system may be a predicted humidity determined by the external computing device using one or more of the location of the aerosol-generating system, the time of day or the time of year. The controller may be configured to control at least one function of the plurality of control functions of the aerosol-generating device based on a combination of the humidity of the of the aerosol-generating article determined by the at least one sensor and the local humidity of the location of the aerosol-generating system. Advantageously, the local humidity of the location of the aerosol-generating system may give an indication as to the likely humidity of the aerosol-generating article.

The controller may be configured to control at least one function of the plurality of control functions of the aerosol-generating device after comparing the humidity of the of the aerosol-generating article determined by the at least one sensor to the local humidity of the location of the aerosol-generating system.

The data indicative of (or dependent on) the location of the aerosol-generating system may comprise a local temperature of the location of the aerosol-generating system.

The controller may be configured to control at least one function of the plurality of control functions of the aerosol-generating device based on a combination of the humidity of the of the aerosol-generating article determined by the at least one sensor and the local temperature of the location of the aerosol-generating system. Advantageously, the local temperature of the location of the aerosol-generating system may give an indication as to the likely characteristics of the aerosol generated by the aerosol-generating article, such that the at least one function of the plurality of control functions of the aerosol-generating device may be controlled accordingly.

The controller may be configured to control at least one function of the plurality of control functions of the aerosol-generating device based on a combination of the humidity of the of the aerosol-generating article determined by the at least one sensor, the local humidity of the location of the aerosol-generating system and the local temperature of the location of the aerosol-generating system.

The at least one sensor may be configured to determine a classification of the aerosol-generating article when the aerosol-generating article is coupled to the aerosol-generating device. The controller may be configured to control at least one function of the plurality of control functions of the aerosol-generating device based on the classification of the aerosol-generating article.

As different classifications of aerosol-generating article can be coupled to and used with the aerosol-generating device, each different classification of aerosol-generating article may have different optimal requirements for generating aerosol. For example, a first classification of aerosol-generating article may need to be heated to a higher temperature than a second classification of aerosol-generating article to generate a desirable aerosol.

The at least one sensor may comprise a classification sensor. The classification sensor may be an optical sensor. Advantageously, a separate classification sensor may more accurately determine the classification of an aerosol-generating article compared to the at least one acoustic sensor.

The classification of the aerosol-generating article when the aerosol-generating article is coupled to the aerosol-generating device may be determined by the first acoustic receiver and the first acoustic emitter. The classification of the aerosol-generating article when the aerosol-generating article is coupled to the aerosol-generating device may be determined by the first acoustic receiver and the second acoustic emitter. Advantageously, the classification of the aerosol-generating article when the aerosol-generating article determined by the at least one sensor means no additional classification sensors may be required. The classification of the aerosol-generating article when the aerosol-generating article is coupled to the aerosol-generating device may be determined by the first acoustic emitter and the second acoustic receiver. The classification of the aerosol-generating article when the aerosol-generating article is coupled to the aerosol-generating device may be determined by the second acoustic emitter and the second acoustic receiver.

The controller may be configured to control at least one function of the plurality of control functions of the aerosol-generating device based on a combination of the classification of the aerosol-generating article and the humidity of the aerosol-generating article. Advantageously, as both the classification of the aerosol-generating article and the humidity of the aerosol-generating article may affect an identical variable, for example, the optimum temperature for aerosol generation, a function associated with this variable, for example a heating profile, may be more accurately controlled by the controller.

The controller may be configured to control at least one function of the plurality of control functions of the aerosol-generating device based on a combination of the location of the aerosol-generating device or the data indicative of (or dependent on) the location of the aerosol-generating device, and the classification of the aerosol-generating article. The controller may be configured to control at least one function of the plurality of control functions of the aerosol-generating device based on a combination of the location of the aerosol-generating device or the data indicative of (or dependent on) the location of the aerosol-generating device, the classification of the aerosol-generating article, and the humidity of the aerosol-generating article.

The aerosol-generating device may comprise a computer readable memory. The controller may be configured to determine the classification of the aerosol-generating article by comparing data from the at least one sensor to classification data stored in the readable computer memory.

The computer readable memory may comprise a plurality of heating profiles. Each of the heating profiles of the plurality of heating profiles may be associated with a classification of a plurality of classifications of the aerosol-generating article and a humidity range of a plurality of humidity ranges of the aerosol-generating article. The controller may be configured to select a selected heating profile from the plurality of heating profiles dependent on the humidity of the aerosol-generating article and the classification of the aerosol-generating article determined by the at least one sensor. The controller may be configured control the supply of power supplied to the one or more heating elements based on the selected heating profile. The one or more heating elements may comprise a resistive or an induction heating element. The one or more hearing elements may be located in and/or around a cavity arranged to receive an aerosol-generating article. The system may comprise the aerosol-generating article, which may be for example a tobacco stick. In another example, the aerosol-generating article may be a cartridge comprising a liquid reservoir. The aerosol-generating article may comprise an aerosol forming substrate comprising nicotine.

The controller may be configured to select the selected heating profile from the plurality of heating profiles dependent on a combination of the local humidity of the location of the aerosol-generating system and the humidity of the aerosol-generating article, and the classification of the aerosol-generating article determined by the at least one sensor.

The controller may be configured to control at least one function of the plurality of control functions of the aerosol-generating device based on a combination of the humidity of the of the aerosol-generating article determined by the at least one sensor, the local humidity of the location of the aerosol-generating system and the classification of the aerosol-generating article determined by the at least one sensor.

The controller may be configured to control at least one function of the plurality of control functions of the aerosol-generating device based on a combination of the humidity of the of the aerosol-generating article determined by the at least one sensor, the local humidity of the location of the aerosol-generating system, the classification of the aerosol-generating article determined by the at least one sensor, and a local temperature of the location of the aerosol-generating system.

According to a sixth aspect of the present disclosure, there is provided a method of operation for an aerosol-generating system. The aerosol-generating system may be the aerosol generating system according to the fifth aspect of the present disclosure. The aerosol-generating system may comprise an aerosol-generating device for generating aerosol from an aerosol-generating article. The aerosol-generating device may be configured to be coupled to the aerosol-generating article. The aerosol-generating device may comprise a controller configured to control at least one function of the plurality of control functions of the aerosol-generating device. The aerosol-generating device may comprise at least one sensor for determining a humidity of the aerosol-generating article when the aerosol-generating article is coupled to the aerosol-generating device,

The method may comprising the step of determining a humidity of the aerosol-generating article when the aerosol-generating article is coupled to the aerosol-generating device. The method may comprising the step of controlling at least one function of the plurality of control functions of the aerosol-generating device based on the humidity of the aerosol-generating article. The aerosol-generating device may comprise an acoustic sensor. The humidity of the aerosol-generating article may be determined by acoustic sensing.

The aerosol-generating device may comprise one or more heating elements. The one or more heating elements may comprise a resistive or an induction heating element. The one or more hearing elements may be located in and/or around a cavity arranged to receive an aerosol-generating article. The system may comprise the aerosol-generating article, which may be for example a tobacco stick. In another example, the aerosol-generating article may be a cartridge comprising a liquid reservoir. The aerosol-generating article may comprise an aerosol forming substrate comprising nicotine. The one or more heating elements may be configured to heat the aerosol-generating article when the aerosol-generating article is coupled to the aerosol-generating device. The aerosol-generating device may comprise a power supply. The controller may be configured to control a supply of power from the power supply to the one or more heating elements.

The at least one function of the plurality of control functions of the aerosol-generating device may comprise controlling the supply of power supplied to the one or more heating elements. Controlling the power supplied to the heating element may comprise controlling a heating profile of the one or more heating elements.

The aerosol-generating device may comprise a computer readable memory. The method further may comprise the step of selecting a heating profile stored in the readable computer memory based on the humidity of the aerosol-generating article.

The at least one function of the plurality of control functions of the aerosol-generating device may comprise stopping the power supplied to the one or more heating elements. The at least one function of the plurality of control functions of the aerosol-generating device may comprise displaying a warning to a user. The at least one function of the plurality of control functions of the aerosol-generating device may comprise displaying a suggestion for at least one user setting of the aerosol-generating device to a user.

The method may comprise the step of determining a classification of the aerosol-generating article when the aerosol-generating article is coupled to the aerosol-generating device. The method may comprise the step of controlling at least one function of the plurality of control functions of the aerosol-generating device based on the classification of the aerosol-generating article.

The method may comprise the step of controlling at least one function of the plurality of control functions of the aerosol-generating device based on a combination of the classification and the humidity of the aerosol-generating article.

The aerosol-generating device may comprise a computer readable memory. The step of determining a classification may comprise comparing data from the at least one sensor to classification data stored in the readable computer memory. The method further may comprise the step of the aerosol-generating device determining the location of the aerosol-generating system or receiving data indicative of (or dependent on) the location of the aerosol-generating system.

The method further may comprise the step of controlling at least one function of the plurality of control functions of the aerosol-generating device based on the location of the aerosol-generating system or data indicative of (or dependent on) the location of the aerosol-generating system.

The method further may comprise the step of the aerosol-generating device communicating with an external computing device, and the external computing device sending data indicative of (or dependent on) the location of the aerosol-generating system or the location of the aerosol-generating system to the aerosol-generating device.

The step of the aerosol-generating device determining the location of the aerosol-generating system or receiving data indicative of (or dependent on) the location of the aerosol-generating system may comprise the step of a user inputting the location of the aerosol-generating system.

The step of the aerosol-generating device determining the location of the aerosol-generating system or receiving data indicative of (or dependent on) the location of the aerosol-generating system may comprise using a global positioning system (GPS) chip, or any other satellite navigation chip. The step of the aerosol-generating device determining the location of the aerosol-generating system or receiving data indicative of (or dependent on) the location of the aerosol-generating system may comprise using data output from a global positioning system (GPS) chip.

The aerosol-generating system may comprise a memory storing data indicative of (or dependent on) the location of the aerosol-generating system. The step of the aerosol-generating device determining the location of the aerosol-generating system or receiving data indicative of (or dependent on) the location of the aerosol-generating system may comprise using the data indicative of (or dependent on) the location of the aerosol-generating system stored in the memory. The data indicative of (or dependent on) the location of the aerosol-generating system may comprise an IP address of the external computing device. The step of the aerosol-generating device determining the location of the aerosol-generating system or receiving data indicative (or dependent on) of the location of the aerosol-generating system may comprise using the IP address of the external computing device.

The step of the aerosol-generating device determining the location of the aerosol-generating system or receiving data indicative of (or dependent on) the location of the aerosol-generating system may comprise using two or more of: GPS data, IP address data and/or data input by the user via a user interface. The step of the aerosol-generating device determining the location of the aerosol-generating system or receiving data indicative of (or dependent on) the location of the aerosol-generating system may comprise confirming that at least one of the GPS data, IP address data and/or data input by the user via a user interface matches at least one of the another of the GPS data, IP address data and/or data input by the user via a user interface. Advantageously, such a system may minimise the likelihood of an incorrect determination of location of the aerosol-generating system, should one of the GPS data, IP address data and/or data input by the user be incorrect.

The data indicative of (or dependent on) the location of the aerosol-generating system may comprise a local humidity of the location of the aerosol-generating system.

The method may comprise the step of controlling at least one function of the plurality of control functions of the aerosol-generating device based on a combination of the humidity of the aerosol-generating article determined by the at least one sensor and the location of the aerosol-generating system or the data indicative of (or dependent on) the location of the aerosol-generating system. The method may comprise the step of controlling at least one function of the plurality of control functions of the aerosol-generating device based on a combination of the humidity of the aerosol-generating article determined by the at least one sensor and the local humidity of the location of the aerosol-generating system. The method may comprise the step of controlling at least one function of the plurality of control functions of the aerosol-generating device after comparing the humidity of the of the aerosol-generating article determined by the at least one sensor to the local humidity of the location of the aerosol-generating system.

The data indicative of (or dependent on) the location of the aerosol-generating system may comprise a local temperature of the location of the aerosol-generating system. The method may comprise the step of controlling at least one function of the plurality of control functions of the aerosol-generating device based on a combination of the humidity of the aerosol-generating article determined by the at least one sensor and the local temperature of the location of the aerosol-generating system.

The method may comprise the step of controlling at least one function of the plurality of control functions of the aerosol-generating device based on a combination of the humidity of the of the aerosol-generating article determined by the at least one sensor, the local humidity of the location of the aerosol-generating system and the local temperature of the location of the aerosol-generating system.

The aerosol-generating system may comprise a computer readable memory. The computer readable memory may comprise a plurality of heating profiles. Each of the plurality of heating profiles may be associated with a classification of a plurality of classifications of the aerosol-generating article and a humidity range of a plurality of humidity ranges of the aerosol-generating article. The method may comprise the step of selecting a selected heating profile from the plurality of heating profiles dependent on the humidity of the aerosol-generating article and the classification of the aerosol-generating article determined by the at least one sensor. The method may comprise the step of controlling the supply of power supplied to the one or more heating elements based on the selected heating profile.

The method may comprise the step of selecting a selected heating profile from the plurality of heating profiles dependent on a combination of the local humidity of the location of the aerosol-generating system and the humidity of the aerosol-generating article, and the classification of the aerosol-generating article determined by the at least one sensor

The method may comprise the step of controlling at least one function of the plurality of control functions of the aerosol-generating device based on a combination of the humidity of the of the aerosol-generating article determined by the at least one sensor, the location of the aerosol-generating system or the data indicative of (or dependent on) the location of the aerosol-generating system, and the classification of the aerosol-generating article determined by the at least one sensor. For example, the method may comprise the step of controlling at least one function of the plurality of control functions of the aerosol-generating device based on a combination of the humidity of the of the aerosol-generating article determined by the at least one sensor, the local humidity of the location of the aerosol-generating system and the classification of the aerosol-generating article determined by the at least one sensor. The method may comprise the step of controlling at least one function of the plurality of control functions of the aerosol-generating device based on a combination of the humidity of the of the aerosol-generating article determined by the at least one sensor, the local humidity of the location of the aerosol-generating system, the classification of the aerosol-generating article determined by the at least one sensor, and the a local temperature of the location of the aerosol-generating system.

In accordance with any preceding aspect, the aerosol-forming article may be in the form of an aerosol-forming rod. By way of example, the aerosol-forming rod may comprise a sheet of homogenised tobacco material gathered to form a rod extending along a longitudinal axis of the aerosol-forming article. As an alternative, the aerosol-forming rod may comprise a cut filler obtained by cutting tobacco leaf material or a reconstituted or homogenised tobacco material.

The aerosol-forming substrate preferably comprises one or more aerosol formers. Upon volatilisation, an aerosol former can convey other vaporised compounds released from the first aerosol-forming substrate upon heating, such as for example nicotine and flavourants, in an aerosol. Suitable aerosol formers for inclusion in the aerosol-generating substrate are known in the art and include, but are not limited to: polyhydric alcohols, such as triethylene glycol, propylene glycol, 1,3-butanediol and glycerol; esters of polyhydric alcohols, such as glycerol mono-, di- or triacetate; and aliphatic esters of mono-, di- or polycarboxylic acids, such as dimethyl dodecanedioate and dimethyl tetradecanedioate. The aerosol-forming substrate may have an aerosol former content of between about 5 percent and about 30 percent by weight on a dry weight basis. Preferably, the aerosol-forming substrate has an aerosol former content of at least about 10 percent by weight on a dry weight basis, more preferably at least about 15 percent by weight on a dry weight basis. The aerosol-forming substrate has preferably an aerosol former content of less than or equal to about 25 percent by weight on a dry weight basis, more preferably less than or equal to about 20 percent by weight on a dry weight basis. In some embodiments, the aerosol-forming substrate has an aerosol former content from 5 percent to 25 percent by weight on a dry weight basis, preferably from 10 percent to 25 percent by weight on a dry weight basis, more preferably from 15 percent to 25 percent by weight on a dry weight basis. In other embodiments, the aerosol-forming substrate has an aerosol former content from 5 percent to 20 percent by weight on a dry weight basis, preferably from 10 percent to 20 percent by weight on a dry weight basis, more preferably from 15 percent to 20 percent by weight on a dry weight basis. These relatively high levels of aerosol former are particularly suitable for an aerosol-forming substrate that is intended to be heated at a temperature of less than 275 degrees Celsius.

In accordance with any preceding aspect, the aerosol-generating system or device may be an inductively heated aerosol-generating system or device. That is, one or more heating elements may comprise one or more inductor elements adapted to generate a fluctuating electromagnetic field within the cavity. The aerosol-forming article may comprise a susceptor element embedded within the aerosol-forming substrate.

Also in accordance with any preceding aspect, the aerosol-generating system or device may be an resistively heated aerosol-generating system or device. The one or more heating elements may comprise one or more resistively heated elements arranged at or about the periphery of the cavity. The one or more resistively heated elements may be arranged at a location facing the aerosol-forming substrate when the aerosol-forming article is coupled to the aerosol-generating device.

Also in accordance with any preceding aspect, the aerosol-generating device may be a handheld aerosol-generating device. Also in accordance with any preceding aspect, the battery may be a Lithium based battery, for example a Lithium-Cobalt, a Lithium-Iron-Phosphate, a Lithium Titanate or a Lithium-Polymer battery. The battery may be a Nickel metal hydride battery or a Nickel cadmium battery. The power supply may be another form of charge storage device such as a capacitor.

As used herein, the term “classification” may refer to a classification of an aerosol-generating article. Differing classifications of aerosol-generating article may be differentiated, or ‘classified’ based on their structural differences. These structural difference may include, but are not limited to, size, shape, weight, density, type of aerosol-forming substrate and tobacco volume.

As used herein, the term “humidity” may refer to the concentration of water vapour present in the air, in particular when used to describe a local environment. The term “humidity” when referring to the humidity of an aerosol-forming substrate or aerosol-forming article may refer to the concentration of water, water content by weight or water content by volume of the aerosol-forming substrate or aerosol-forming article. For example, an aerosol-forming substrate with a high humidity may have a high water content by weight.

As used herein, the term “ultrasound” may refer to high-frequency sound. Ultrasound may be defined as a sound with a frequency above 10, 20, 30, or 50 kilohertz.

As used herein, the term “heating zone” may refer to a portion of a cavity configured to receive an aerosol-generating article which is heated to an aerosol-generating temperature, such that aerosol may be generated from the aerosol-generating article. For example, the heating zone may be heated to at least 50, 100, 150, 200, 250, or 300 degrees Celsius.

As used herein, the term “heating element” refers to an element of a heater assembly, the element being configured to be heated. For example, the term “heating element” may refer to an element configured for at least a portion of the element to be heated to at least 50, 100, 150, 200, 250, or 300 degrees Celsius.

As used herein, the term ‘coupled or couplable’ is used to mean that the aerosol-generating article and aerosol-generating device can be coupled and uncoupled from one another and without significantly damaging either the device or article.

As used herein with reference to the invention, the term “aerosol” is used to describe a dispersion of solid particles, or liquid droplets, or a combination of solid particles and liquid droplets, in a gas. The aerosol may be visible or invisible. The aerosol may include vapours of substances that are ordinarily liquid or solid at room temperature as well as solid particles, or liquid droplets, or a combination of solid particles and liquid droplets.

As used herein, the term “firmware” is used to describe computer code configured to control a device. Though “firmware” shall be used throughout this disclosure, “software” may equally be used to describe such code, and the terms “firmware” and “software” may be considered interchangeable for the purpose of this disclosure.

As used herein, an “aerosol-generating system” means a system that generates an aerosol from one or more aerosol-forming substrates.

As used herein, the term “aerosol-forming substrate” means a substrate capable of releasing volatile compounds that may form an aerosol. Such volatile compounds may be released by heating the aerosol-forming substrate.

The invention is defined in the claims. However, below there is provided a non-exhaustive list of non-limiting examples. Any one or more of the features of these examples may be combined with any one or more features of another example, embodiment, or aspect described herein.
Example Ex1. An aerosol-generating system, the aerosol-generating system comprising;
   a location determining apparatus, the location determining apparatus configured to determine a location of the aerosol-generating system, and
   a controller, the controller configured to control a plurality of control functions of the aerosol-generating system, the aerosol-generating system being configured to adjust the control of at least one function of the plurality of control functions based on the location of the aerosol-generating system determined by the location determining apparatus.
Example Ex2. An aerosol-generating system according to example Ex1, wherein the aerosol-generating system comprises an aerosol-generating device, and the plurality of control functions of the aerosol-generating system is a plurality of control functions of the aerosol-generating device.
Example Ex3. An aerosol-generating system according to example Ex2, wherein the aerosol-generating system comprises an external computing device, the external computing device comprising the location determining apparatus configured to output location data indicative of the location of the aerosol-generating system.
Example Ex4. An aerosol-generating system comprising;
   an aerosol-generating device and an external computing device separate from the aerosol-generating device;
   the external computing device comprises a location determining apparatus configured to output location data indicative of the location of the aerosol-generating system,
   the aerosol-generating device comprises a controller configurable to perform a plurality of control functions for controlling the aerosol-generating device,
   the aerosol-generating system being configured to select at least one of the plurality of control functions based on the location data;
   the external computing device being configured to cause the controller to be configured to perform the selected control functions.
Example Ex5. An aerosol-generating system according to example Ex3 or Ex4 wherein the external computing device is a personal computing device (e.g. a smartphone).
Example Ex6. An aerosol-generating system according to example Ex3, Ex4 or Ex5, wherein the external computing device is configured to communicate with the aerosol-generating device using a communications interface.
Example Ex7. An aerosol-generating system according to example Ex6 wherein the communications interface is a wireless communications interface (e.g. Bluetooth, or Wi-Fi).
Example Ex8. An aerosol-generating system according to example Ex6 or Ex7, wherein the communications interface is a wired communications interface (e.g. a USB connection).
Example Ex9. An aerosol-generating system according to any one of examples Ex1 to Ex8, wherein the plurality of control functions is a predefined set of control functions.
Example Ex10. An aerosol-generating system according to any one of examples Ex3 to Ex9, wherein the external computing device is configured to send the location data or data derived from the location data to the controller
Example Ex11. An aerosol-generating system according to any one of examples Ex3 to Ex10, wherein the external computing device is configured to wirelessly send the location data or data derived from the location data to the controller.
Example Ex12. An aerosol-generating system according to any one of examples Ex10 to Ex11, wherein the data derived from the location data comprises firmware comprising at least one function of the plurality of control functions for controlling the aerosol-generating device.
Example Ex13. An aerosol-generating system according to any preceding claim, wherein the location determining apparatus comprises a global positioning system (GPS) chip.
Example Ex14. An aerosol-generating system according to example Ex13, wherein the location determining apparatus determines the location data based on data output from the GPS chip.
Example Ex15. An aerosol-generating system according to any one of examples Ex3 to Ex14, wherein the external computing device comprises a memory storing data indictive of the location of the external computing device.
Example Ex16. An aerosol-generating system according to example Ex15, wherein the memory stores an IP address of the external computing device.
Example Ex17. An aerosol-generating system according to example Ex15 or Ex16, wherein the location determining apparatus determines the location data from data stored in the memory of the external computing device.
Example Ex18. An aerosol-generating system according to any one of examples Ex1 to Ex17, wherein the location determining apparatus comprises a user interface for a user to input data indicative of the location of the aerosol-generating system or the location of the aerosol-generating system.
Example Ex19. An aerosol-generating system according to any one of examples Ex1 to Ex18, wherein the location determining apparatus determines the location data based on the location input by the user.
Example Ex20. An aerosol-generating system according to any one of examples Ex1 to Ex19, wherein the location determining apparatus determines the location data based on a combination of two or more of: GPS data, IP address data and/or data input by the user via a user interface.
Example Ex21. An aerosol-generating system according to example Ex20, wherein the location determining apparatus determines the location data after confirming that at least one of the GPS data, IP address data and/or data input by the user via a user interface matches at least one of the another of the GPS data, IP address data and/or data input by the user via a user interface.
Example Ex22. An aerosol-generating system according to any one of examples Ex3 to Ex21, wherein selecting at least one of the plurality of control functions based on the location data comprises the external computing device selecting a firmware version based on the location data.
Example Ex23. An aerosol-generating system according to example Ex22, wherein the external computing device being configured to cause the controller to be configured to perform the selected control functions comprises the external computing device being configured to select a firmware version from a plurality of firmware versions available at a server.
Example Ex24. An aerosol-generating system according to example Ex23, wherein the external computing device being configured to select a firmware version from a plurality of firmware versions available at a server comprises the external computing device being configured to send a request to the server and the external computing device being configured to receive firmware from the server for controlling the aerosol-generating device.
Example Ex25. An aerosol-generating system according to any one of examples Ex22 to Ex24, wherein the external computing device being configured to cause the controller to be configured to perform the selected control functions comprises the external computing device being configured to load the selected firmware onto the aerosol-generating device.
Example Ex26. An aerosol-generating system according to example Ex25, wherein the external computing device being configured to load the selected firmware onto the aerosol-generating device comprises the external computing device being configured to load the selected firmware onto the controller.
Example Ex27. An aerosol-generating system according to any one of examples Ex3 to Ex26, wherein the aerosol-generating system being configured to select at least one of the plurality of control functions based on the location data comprises the external computing device or the aerosol-generating device being configured to select one or more functions from a plurality of functions each associated with a location.
Example Ex28. An aerosol-generating system according to Example Ex27, wherein the selected functions are each associated with a location corresponding with the location data.
Example Ex29. An aerosol-generating system according to any one of examples Ex4 to Ex28, wherein the plurality of control functions for controlling the aerosol-generating device comprises at least one function for controlling an age verification process.
Example Ex30. An aerosol-generating system according to example Ex30 or Ex31, wherein the power supply is a rechargeable power supply, and the at least one function of the plurality of control functions of the aerosol-generating system comprises controlling the power supplied to the power supply during charging.
Example Ex31. An aerosol-generating system according to any one of examples Ex1 to Ex30, wherein the aerosol-generating system comprises one or more heating elements.
Example Ex32. An aerosol-generating system according to example Ex31, wherein the aerosol-generating system comprises a power supply for supplying power to the one or more heating elements, wherein the controller controls the power supplied from the power supply to the one or more heating elements.
Example Ex33. An aerosol-generating system according to example Ex32, wherein at least one function of the plurality of control functions of the aerosol-generating system comprises controlling the power supplied to the one or more heating elements for heating the aerosol-generating article.
Example Ex34. An aerosol-generating system according to any one of examples Ex31 to Ex33, wherein the aerosol-generating device comprises the one or more heating elements.
Example Ex35. An aerosol-generating system according to any one of examples Ex31 to Ex34, wherein each of the plurality of control functions is a predetermined heating profile
Example Ex36. An aerosol-generating system according to example Ex35, wherein the predetermined heating profile is defined by one or more parameters, such as temperature, resistance, conductance, voltage and/or current, to be applied at one or more stages in a heating cycle.
Example Ex37. An aerosol-generating system according to any one of examples Ex31 to Ex36, wherein the selected control function of the plurality of control functions is a predetermined heating profile
Example Ex38. An aerosol-generating system according to example Ex37, wherein the predetermined heating profile is defined by one or more parameters, such as temperature, resistance, conductance, voltage and/or current, to be applied at one or more stages in a heating cycle.
Example Ex39. An aerosol-generating system according to any one of examples Ex1 to Ex38, wherein the aerosol-generating system comprises a computer readable memory.
Example Ex40. An aerosol-generating system according to example Ex39, wherein the aerosol-generating system being configured to select at least one of the plurality of control functions based on the location data comprises the aerosol-generating system being configured to select a heating profile from a plurality of heating profiles stored on the computer readable memory.
Example Ex41. An aerosol-generating system according to example Ex39 or Ex40, wherein the aerosol-generating system being configured to select at least one of the plurality of control functions based on the location data comprises the aerosol-generating system being configured to select a power supply profile from a plurality of power supply profiles stored on the computer readable memory.
Example Ex42. An aerosol-generating system according to any one of examples Ex39 to Ex41, wherein the aerosol-generating system being configured to select at least one of the plurality of control functions based on the location data comprises the aerosol-generating system being configured to select an age verification process from a plurality of age verification processes stored on the computer readable memory.
Example Ex43. An aerosol-generating system according to any one of examples Ex1 to Ex42, wherein the aerosol-generating system is configured to generate an aerosol comprising nicotine.
Example Ex44. An aerosol-generating system according to any one of examples Ex1 to Ex43, further comprising an aerosol-generating article.
Example Ex45. An aerosol-generating system according to example Ex 44, wherein the aerosol-generating article comprises an aerosol-generating substrate comprising nicotine.
Example Ex46. A method of controlling an aerosol-generating system, the method comprising the steps of:
determining a location of the aerosol-generating system, and adjusting the control of at least one function of a plurality of control functions of the aerosol-generating system based on the location of the aerosol-generating system determined by the aerosol-generating system.
Example Ex47. A method of controlling an aerosol-generating system according to example Ex46, wherein the aerosol-generating system comprises an aerosol-generating device, and the step of adjusting the control of the at least one function of the plurality of control functions of the aerosol-generating system based on the location of the aerosol-generating system comprises adjusting the control of at least one function of a plurality of control functions of the aerosol-generating device based on the location of the aerosol-generating system.
Example Ex47A. A method of controlling an aerosol-generating system according to example Ex47, wherein the aerosol-generating system comprises an external computing device separate from the aerosol-generating device, wherein the external computing device comprises a location determining apparatus configured to output location data indicative of the location of the aerosol-generating system, and wherein the aerosol-generating device comprises a controller configurable to perform a plurality of control functions for controlling the aerosol-generating device.
Example Ex48. A method of controlling an aerosol-generating system, the aerosol-generating system comprising an aerosol-generating device and an external computing device separate from the aerosol-generating device, wherein the external computing device comprises a location determining apparatus configured to output location data indicative of the location of the aerosol-generating system, and wherein the aerosol-generating device comprises a controller configurable to perform a plurality of control functions for controlling the aerosol-generating device, the method comprising the steps of:
   the external computing device determining a location of the aerosol-generating system,
   the external computing device outputting location data indicative of the location of the aerosol-generating system,
   the aerosol-generating system selecting at least one of a plurality of control functions based on the location data, and
   the external computing device causing the controller to be configured to perform the selected control functions.
Example Ex49. A method of controlling an aerosol-generating system according to example Ex47A or Ex48, wherein the external computing device is configured to communicate with the aerosol-generating device using a communications interface.
Example Ex50. A method of controlling an aerosol-generating system according to example Ex49, wherein the location determining apparatus comprises a user interface for a user to input data indicative of the location of the aerosol-generating system or the location of the aerosol-generating system, and wherein the step of determining the location of the aerosol-generating system further comprises the user inputting data indicative of the location of the aerosol-generating system or the location of the aerosol-generating system using the interface.
Example Ex51. A method of controlling an aerosol-generating system according to example Ex49 or Ex50, wherein the location determining apparatus comprises a global positioning system (GPS) chip.
Example Ex52. A method of controlling an aerosol-generating system according to example Ex51, wherein the location determining apparatus determines the location data based on data output from the GPS chip.
Example Ex53. A method of controlling an aerosol-generating system according to any one of examples Ex49 to Ex52, wherein the location determining apparatus comprises memory storing data indictive of the location of the external computing device, preferably the memory stores the IP address of the external computing device.
Example Ex54. A method of controlling an aerosol-generating system according to example Ex53, wherein the location determining apparatus determines the location data from data stored at the memory of the external computing device.
Example Ex55. A method of controlling an aerosol-generating system according to any one of examples Ex48 to Ex54, wherein the location determining apparatus determines the location data based on a combination of two or more of: GPS data, IP address data and/or data input by the user via a user interface.
Example Ex56. A method of controlling an aerosol-generating system according to example Ex55, wherein the location determining apparatus determines the location data after confirming that at least one of the GPS data, IP address data and/or data input by the user via a user interface matches at least one of the another of the GPS data, IP address data and/or data input by the user via a user interface.
Example Ex57. A method of controlling an aerosol-generating system according to any one of examples Ex47A to Ex56, wherein the external computing device is configured to communicate with the aerosol-generating device using a communications interface.
Example Ex58. A method of controlling an aerosol-generating system according to example Ex57, wherein the external computing device is a personal computing device.
Example Ex59. A method of controlling an aerosol-generating system according to example Ex57 or Ex58, wherein the communications interface is a wireless communications interface.
Example Ex60. A method of controlling an aerosol-generating system according to example Ex57 or Ex59, wherein the communications interface is a wired communications interface.
Example Ex61. A method of controlling an aerosol-generating system according to any one of examples Ex46 to Ex60, wherein the plurality of control functions is a predefined set of control functions.
Example Ex62. A method of controlling an aerosol-generating system according to any one of examples Ex47A to Ex61, wherein the step of causing the controller to be configured to perform the selected control functions comprises the external computing device sending the location data or data derived from the location of the aerosol-generating system to the aerosol-generating device.
Example Ex63. A method of controlling an aerosol-generating system according to any one of examples Ex47A to Ex62, wherein the step of causing the controller to be configured to perform the selected control functions comprises the external computing device wirelessly sending the location data or data derived from the location of the aerosol-generating system to the aerosol-generating device.
Example Ex64. A method of controlling an aerosol-generating system according to any one of examples Ex62 to Ex63, wherein the data derived from the location data comprises firmware for causing the controller to be configured to perform the selected control function.
Example Ex65. A method of controlling an aerosol-generating system according to example Ex64, wherein the step of the aerosol-generating system selecting at least one of a plurality of control functions based on the location data comprises the external computing device sending firmware to the aerosol-generating device.
Example Ex66. A method of controlling an aerosol-generating system according to any of claims Ex64 or Ex65, wherein the step of the aerosol-generating system selecting at least one of a plurality of control functions based on the location data comprises the aerosol-generating system sending a request to a server and the aerosol-generating system receiving firmware from the server for causing the controller to be configured to perform the selected control function.
Example Ex67. A method of controlling an aerosol-generating system according to example Ex66, wherein the aerosol-generating system receiving firmware from the server for causing the controller to be configured to perform the selected control functions comprises the controller receiving firmware from the server for causing the controller to be configured to perform the selected control function.
Example Ex68. A method of controlling an aerosol-generating system according to any of examples Ex46 to Ex67, wherein the aerosol-generating system comprises a power supply for supplying power to one or more heating elements, wherein the controller controls the power supplied from the power supply to the one or more heating elements.
Example Ex69. A method of controlling an aerosol-generating system according to example Ex68, wherein the aerosol-generating system comprises the one or more heating elements.
Example Ex70. A method of controlling an aerosol-generating system according to example Ex69, wherein the aerosol-generating device comprises the one or more heating elements.
Example Ex71. A method of controlling an aerosol-generating system according to any one of examples Ex68 to Ex70, wherein the step of causing the controller to be configured to perform the selected control functions comprises causing the controller to be configured to control the power supplied to the one or more heating elements for heating the aerosol-generating article.
Example Ex72. A method of controlling an aerosol-generating system according to any one of examples Ex68 to Ex71, wherein each of the plurality of control functions is a predetermined heating profile
Example Ex73. A method of controlling an aerosol-generating system according example Ex72, wherein the predetermined heating profile is defined by one or more parameters, such as temperature, resistance, conductance, voltage and/or current, to be applied at one or more stages in a heating cycle.
Example Ex74. A method of controlling an aerosol-generating system according to any one of examples Ex70 to Ex73, wherein the selected control function of the plurality of control functions is a predetermined heating profile
Example Ex75. A method of controlling an aerosol-generating system according example Ex74, wherein the predetermined heating profile is defined by one or more parameters, such as temperature, resistance, conductance, voltage and/or current, to be applied at one or more stages in a heating cycle.
Example Ex76. A method of controlling an aerosol-generating system according to any of examples Ex46 to Ex75, wherein the power supply is a rechargeable power supply, and wherein the step of causing the controller to be configured to perform the selected control functions comprises causing the controller to be configured to control the power supplied to the power supply during charging.
Example Ex77. A method of controlling an aerosol-generating system according to any of examples Ex46 to Ex76, wherein the step of causing the controller to be configured to perform the selected control functions comprises causing the controller to be configured to control an age verification process.
Example Ex78. A method of controlling an aerosol-generating system according to any of examples Ex46 to Ex77, wherein the aerosol-generating system comprises a computer readable memory.
Example Ex79. A method of controlling an aerosol-generating system according to example Ex78, wherein the step of controlling at least one function of the plurality of control functions of the aerosol-generating system based on the location of the aerosol-generating system comprises selecting a heating profile from a plurality of heating profiles stored on the computer readable memory.
Example Ex80. A method of controlling an aerosol-generating system according to example Ex78 or Ex79, wherein the step of causing the controller to be configured to perform the selected control functions comprises selecting a power supply profile from a plurality of power supply profiles stored on the computer readable memory.
Example Ex81. A method of controlling an aerosol-generating system according to any of examples Ex78 to Ex80, wherein the step of causing the controller to be configured to perform the selected control functions comprises selecting an age verification process from a plurality of age verification processes stored on the computer readable memory.
Example Ex82. An aerosol-generating device, the aerosol-generating device comprising;
   a controller, the controller configured to receive data indicative of a location of the aerosol-generating device,
   wherein the controller is configured to control at least one function of a plurality of control functions of the aerosol-generating device, the control of the at least one function of the plurality of control functions being dependent on the data indicative of the location of the aerosol-generating device received by the controller.
Example Ex83. An aerosol-generating device comprising;
   a controller configured to receive data indicative of a location of the aerosol-generating device,
   wherein the controller is configured to select at least one control function of the aerosol-generating device from a plurality of control functions for the aerosol-generating device based on the data indicative of the location of the aerosol-generating device received by the controller; and
   wherein the controller is configured to control the aerosol-generating device using the selected control function.
Example Ex84. An aerosol-generating device according to example Ex82 or Ex83, wherein the controller is configured to receive data indicative of the location of the aerosol-generating device from an external computing device configured to communicate with the aerosol-generating device.
Example Ex85. An aerosol-generating device according to example Ex84, wherein the controller is configured to communicate with the external computing device, and the controller is configured to receive data indicative of the location of the aerosol-generating system from the external computing device.
Example Ex86. An aerosol-generating device according to example Ex85, wherein the controller is configured to wirelessly communicate with the external computing device (e.g. the personal computing device), and the controller is configured to wirelessly receive data indicative of the location of the aerosol-generating device from the external computing device.
Example Ex87. An aerosol-generating device according to any of examples Ex82 to Ex86, wherein the data indicative of the location of the aerosol-generating system comprises firmware comprising at least one function of the plurality of control functions for controlling the aerosol-generating device.
Example Ex88. An aerosol-generating device according to any of examples Ex82 to Ex87, wherein the aerosol-generating device comprises device location determining apparatus, the device location determining apparatus configured to send data indicative of the location of the aerosol-generating device to the controller.
Example Ex89. An aerosol-generating device according to example Ex88, wherein the device location determining apparatus comprises a global positioning system (GPS) chip.
Example Ex90. An aerosol-generating device according to example Ex89, wherein the device location determining apparatus determines the location data based on data output from the GPS chip.
Example Ex91. An aerosol-generating device according to any of examples Ex88 to Ex90, wherein the device location determining apparatus comprises memory storing data indictive of the location of the device.
Example Ex92. An aerosol-generating device according to example Ex91, wherein the data indictive of the location of the device comprises an IP address of an external computing device.
Example Ex93. An aerosol-generating device according to example Ex91 or Ex92, wherein the device location determining apparatus determines the location data from data indictive of the location of the device stored in the memory of the aerosol-generating device.
Example Ex94. An aerosol-generating device according to any of examples Ex88 to Ex93, wherein the device location determining apparatus comprises a user interface for a user to input data indicative of the location of the aerosol-generating system or the location of the aerosol-generating system, preferably wherein the location determining apparatus determines the location data based on the location input by the user.
Example Ex95. An aerosol-generating device according to any of examples Ex88 to Ex94, wherein the device location determining apparatus determines the location data based on a combination of two or more of: GPS data, IP address data and/or data input by the user via a user interface.
Example Ex96. An aerosol-generating system according to example Ex95, wherein the location determining apparatus determines the location data after confirming that at least one of the GPS data, IP address data and/or data input by the user via a user interface matches at least one of the another of the GPS data, IP address data and/or data input by the user via the user interface.
Example Ex97. An aerosol-generating device according to any of examples Ex88 to Ex96, wherein the controller is configured to receive firmware from a server indicative of the location of the aerosol-generating device, the firmware for controlling at least one function of the plurality of control functions of the aerosol-generating device.
Example Ex98. An aerosol-generating device according to any of examples Ex88 to Ex97, wherein the aerosol-generating device comprises a power supply for supplying power to one or more heating elements, wherein the controller controls the power supplied from the power supply to the one or more heating elements.
Example Ex99. An aerosol-generating device according to example Ex98, wherein the aerosol-generating device comprises the one or more heating elements.
Example Ex100. An aerosol-generating device according to example Ex98 or Ex99, wherein at least one function of the plurality of control functions of the aerosol-generating device comprises controlling the power supplied to the one or more heating elements for heating the aerosol-generating article.
Example Ex101. An aerosol-generating device according to any one of examples Ex98 to Ex100, wherein each of the plurality of control functions is a predetermined heating profile.
Example Ex102. An aerosol-generating device according to example Ex100, wherein the predetermined heating profile is defined by one or more of temperature, resistance, conductance, voltage and/or current, to be applied at one or more stages in a heating cycle.
Example Ex103. An aerosol-generating device according to any one of examples Ex98 to Ex102, wherein the selected control function is a predetermined heating profile.
Example Ex104. An aerosol-generating device according to example Ex103, wherein the predetermined heating profile is defined by one or more of temperature, resistance, conductance, voltage and/or current, to be applied at one or more stages in a heating cycle.
Example Ex105. An aerosol-generating device according to any one of examples Ex98 to Ex104, wherein the power supply is a rechargeable power supply, and the at least one function of the plurality of control functions of the aerosol-generating device comprises controlling the power supplied to the power supply during charging.
Example Ex106. An aerosol-generating device according to any one of examples Ex98 to Ex105, wherein the at least one function of the plurality of control functions of the aerosol-generating device comprises controlling an age verification process.
Example Ex107. An aerosol-generating device according to any one of examples Ex98 to Ex106, wherein the aerosol-generating device comprises a computer readable memory.
Example Ex108. An aerosol-generating device according to example Ex107, wherein the at least one function of the plurality of control functions of the aerosol-generating device comprises selecting a heating profile from a plurality of heating profiles stored on the computer readable memory.
Example Ex109. An aerosol-generating device according to example Ex107 or Ex108, wherein the at least one function of the plurality of control functions of the aerosol-generating device comprises selecting a power supply profile from a plurality of power supply profiles stored on the computer readable memory.
Example Ex110. An aerosol-generating device according to any one of examples Ex107 to Ex109, wherein the power supply is a rechargeable power supply, and wherein the at least one function of the plurality of control functions of the aerosol-generating device comprises selecting an age verification process from a plurality of age verification processes stored on the computer readable memory.
Example Ex111. An aerosol-generating device according to any one of examples Ex107 to Ex110, wherein the aerosol-generating device is configured to generate an aerosol comprising nicotine.
Example Ex112. An aerosol-generating device according to any one of examples Ex107 to

Ex111, wherein the aerosol-generating device is a handheld aerosol-generating device.
Example Ex113. An aerosol-generating device for generating aerosol from an aerosol-generating article, the aerosol-generating device comprising;
   at least one sensor configured to determine a humidity of the aerosol-generating article, and
   a controller configured to control at least one function of a plurality of control functions of the aerosol-generating device based on the humidity of the aerosol-generating article determined by the at least one sensor.
Example Ex114. An aerosol-generating device according to example Ex113, wherein the aerosol-generating device further comprises one or more heating elements, the one or more heating elements configured to heat the aerosol-generating article, and
   a power supply, the controller configured to control a supply of power from the power supply to the one or more heating elements.
Example Ex115. An aerosol-generating device according to example Ex113, wherein the aerosol-generating device is couplable to an aerosol-generating article comprising one or more heating elements, wherein the aerosol-generating device comprises a power supply, the controller configured to control a supply of power from the power supply to the one or more heating elements.
Example Ex116. An aerosol-generating device according to example Ex115, further comprising a cavity for receiving an aerosol-generating article.
Example Ex117. An aerosol-generating device according to example Ex116, wherein the at least one sensor is configured to determine a humidity of the aerosol-generating article when the aerosol-generating article is received in the cavity.
Example Ex118. An aerosol-generating device according to any one of examples Ex114 to Ex117, wherein the at least one function of the plurality of control functions of the aerosol-generating device comprises controlling the supply of power supplied to the one or more heating elements.
Example Ex119. An aerosol-generating device according to any one of examples Ex114 to Ex118, wherein the at least one function of the plurality of control functions of the aerosol-generating device comprises controlling a heating profile of the one or more heating elements.
Example Ex120. An aerosol-generating device according to example Ex119, wherein the aerosol-generating device comprises a computer readable memory, and the controller is configured to select a heating profile stored in the readable computer memory based on the humidity of the aerosol-generating article.
Example Ex121. An aerosol-generating device according to any of examples Ex113 to Ex120, wherein the at least one function of the plurality of control functions of the aerosol-generating device comprises stopping the power supplied to the one or more heating elements.
Example Ex122. An aerosol-generating device according to any of examples Ex113 to Ex121, wherein the at least one function of the plurality of control functions of the aerosol-generating device comprises displaying a warning to a user.
Example Ex123. An aerosol-generating device according to any of examples Ex113 to Ex122, wherein the at least one function of the plurality of control functions of the aerosol-generating device comprises displaying a suggestion for at least one user setting of the aerosol-generating device to a user.
Example Ex124. An aerosol-generating device according to any of examples Ex113 to Ex123, wherein the at least one sensor comprises at least one acoustic sensor.
Example Ex125. An aerosol-generating device according to example Ex124, wherein the acoustic sensor comprises at least one acoustic transceiver.
Example Ex126. An aerosol-generating device according to example Ex125, wherein the at least one acoustic sensor comprises at least one acoustic emitter configured to emit sound waves with at least one frequency and at least one acoustic receiver configured to receive the sound waves with the at least one frequency.
Example Ex127. An aerosol-generating device according to example Ex126 when dependent on example Ex116, wherein the at least one acoustic emitter comprises a first acoustic emitter positioned adjacent to the cavity, and the at least one acoustic receiver comprises a first acoustic receiver positioned adjacent to the cavity,
Example Ex128. An aerosol-generating device according to example Ex127, wherein the sound waves emitted by the first acoustic emitter and received by the first acoustic receiver propagate through the aerosol-generating article when the aerosol-generating article is received in the cavity.
Example Ex129. An aerosol-generating device according to example Ex127 or Ex128, wherein the cavity comprises a proximal end located at the opening of the cavity and a distal end located at an opposite end of the cavity to the proximal end, and a heating zone located between the distal end and the proximal end.
Example Ex130. An aerosol-generating device according to example Ex129, wherein the heating zone does not extend to the distal end and does not extend to the proximal end.
Example Ex131. An aerosol-generating device according to example Ex129 or Ex130, wherein the first acoustic receiver and the first acoustic emitter are positioned outside of the heating zone.
Example Ex132. An aerosol-generating device according to any of examples Ex129 to Ex131, wherein the first acoustic receiver and the first acoustic emitter are positioned on opposite sides of the heating zone to one another, such that the sound waves emitted by the first acoustic emitter and received by the first acoustic receiver propagate through the aerosol-generating article when the aerosol-generating article is received in the cavity.
Example Ex133. An aerosol-generating device according to any of examples Ex129 to Ex132, wherein the first acoustic receiver is positioned at the proximal end of the cavity and the first acoustic emitter is positioned at the distal end of the cavity.
Example Ex134. An aerosol-generating device according to any of examples Ex129 to Ex133, wherein the at least one acoustic emitter further comprises a second acoustic emitter.
Example Ex135. An aerosol-generating device according to example Ex134, wherein the first acoustic emitter and the second acoustic emitter are positioned on opposite sides of the heating zone to one another.
Example Ex136. An aerosol-generating device according to example Ex134 or Ex135, wherein the first acoustic emitter is positioned at the distal end of the cavity and the second acoustic emitter is positioned at the proximal end of the cavity.
Example Ex137. An aerosol-generating device according to any of examples Ex134 to Ex136, wherein the first acoustic emitter and the second acoustic emitter are positioned such that the sound waves emitted from the first acoustic emitter are configured to propagate through a first portion of the aerosol-generating article when the aerosol-generating article is received in the cavity, and the sound waves emitted from the second acoustic emitter are configured to propagate through a second portion of the aerosol-generating article when the aerosol-generating article is received in the cavity.
Example Ex138. An aerosol-generating device according to any of examples Ex129 to Ex137, wherein the at least one acoustic receiver further comprises a second acoustic receiver.
Example Ex139. An aerosol-generating device according to example Ex138, wherein the first acoustic receiver and the second acoustic receiver are positioned on opposite sides of the heating zone to one another.
Example Ex140. An aerosol-generating device according to example Ex139, wherein the first acoustic receiver is positioned at the distal end of the cavity and the second acoustic receiver is positioned at the proximal end of the cavity.
Example Ex141. An aerosol-generating device according to any one of examples Ex138 to Ex140, wherein the first acoustic receiver and the second acoustic receiver are positioned such that the sound waves received by the first acoustic receiver are configured to propagate through a first portion of the aerosol-generating article when the aerosol-generating article is received in the cavity, and the sound waves received by the second acoustic receiver are configured to propagate through a second portion of the aerosol-generating article when the aerosol-generating article is received in the cavity.
Example Ex142. An aerosol-generating device according to any of examples Ex138 to Ex141, wherein the first acoustic receiver and the first acoustic emitter are positioned on the same side of the heating zone as one another.
Example Ex143. An aerosol-generating device according to any of examples Ex129 to Ex142, wherein the first acoustic emitter is configured to emit sound waves which propagate through the heating zone to the distal end of the cavity, and propagate back from the distal end of the cavity through the heating zone to the first acoustic receiver.
Example Ex144. An aerosol-generating device according to any of examples Ex126 to Ex143, wherein the at least one frequency comprises a plurality of different frequencies.
Example Ex145. An aerosol-generating device according to any of examples Ex126 to Ex144, wherein the at least one frequency comprises an ultrasound frequency.
Example Ex146. An aerosol-generating device according to example Ex145, wherein the at least one frequency comprises a frequency greater that 20 kilohertz.
Example Ex147. An aerosol-generating device according to any of examples Ex113 to Ex146, wherein the aerosol-generating device is configured to determine the location of the aerosol-generating device or receive data indicative of a location of the aerosol-generating device.
Example Ex148. An aerosol-generating device according to example Ex147 wherein the controller is configured to control at least one function of the plurality of control functions of the aerosol-generating device based on the location of the aerosol-generating device or the data indicative of the location of the aerosol-generating device.
Example Ex149. An aerosol-generating device according to example Ex147 or Ex148, wherein the aerosol-generating device further comprises a device location determining apparatus, the device location determining apparatus configured to determine the location of the aerosol-generating device.
Example Ex150. An aerosol-generating system comprising an aerosol-generating device according to example Ex147 or Ex148, wherein the aerosol-generating system further comprises an external computing device, the external computing device connected to the aerosol-generating device.
Example Ex151. An aerosol-generating system according to example Ex150, wherein the aerosol-generating device comprises the controller.
Example Ex152. An aerosol-generating system according to example Ex151, wherein the external computing device comprises a system location determining apparatus, the system location determining apparatus configured to output location data indicative of the location of the aerosol-generating system.
Example Ex153. An aerosol-generating system according to example Ex152, wherein the external computing device is configured to send the location data indicative of the location of the aerosol-generating system or the location of the aerosol-generating system to the controller.
Example Ex154. An aerosol-generating system according to any of examples Ex149 to Ex153, wherein the system location determining apparatus comprises a user interface for a user to input data indicative of the location of the aerosol-generating system or the location of the aerosol-generating system.
Example Ex155. An aerosol-generating system according to any of examples Ex150 to Ex154, wherein the system location determining apparatus comprises a global positioning system (GPS) chip.
Example Ex156. An aerosol-generating system according to example Ex155, wherein the system location determining apparatus determines the location data based on data output from the GPS chip
Example Ex157. An aerosol-generating system according to any of examples Ex150 to Ex156, wherein the system location determining apparatus comprises memory storing data indictive of the location of the external computing device.
Example Ex158. An aerosol-generating system according to example Ex157, wherein the data indictive of the location of the external computing device comprises the IP address of the external computing device.
Example Ex159. An aerosol-generating system according to example Ex158, wherein the system location determining apparatus determines the location data from data stored in the memory of the external computing device.
Example Ex160. An aerosol-generating system according to example Ex159, wherein the system location determining apparatus determines the location data based on a combination of two or more of: GPS data, IP address data and/or data input by the user via a user interface.
Example Ex161. An aerosol-generating system according to example Ex160, wherein the location determining apparatus determines the location data after confirming that at least one of the GPS data, IP address data and/or data input by the user via a user interface matches at least one of the another of the GPS data, IP address data and/or data input by the user via a user interface.
Example Ex162. An aerosol-generating system according to any of examples Ex147 to Ex161, wherein the data indicative of the location of the aerosol-generating system comprises a local humidity of the location of the aerosol-generating system.
Example Ex163. An aerosol-generating system according to example Ex162, wherein the controller is configured to control at least one function of the plurality of control functions of the aerosol-generating device based on a combination of the humidity of the of the aerosol-generating article determined by the at least one sensor and the local humidity of the location of the aerosol-generating system.
Example Ex164. An aerosol-generating system according to example Ex163, wherein the controller is configured to control at least one function of the plurality of control functions of the aerosol-generating device after comparing the humidity of the of the aerosol-generating article determined by the at least one sensor to the local humidity of the location of the aerosol-generating system.
Example Ex165. An aerosol-generating system according to any of claims Ex147 to Ex164, wherein the data indicative of the location of the aerosol-generating system comprises a local temperature of the location of the aerosol-generating system.
Example Ex166. An aerosol-generating system according to example Ex165, wherein the controller is configured to control at least one function of the plurality of control functions of the aerosol-generating device based on a combination of the humidity of the of the aerosol-generating article determined by the at least one sensor and the local temperature of the location of the aerosol-generating system.
Example Ex167. An aerosol-generating system according to example Ex166 when dependent on example Ex162, wherein the controller is configured to control at least one function of the plurality of control functions of the aerosol-generating device based on a combination of the humidity of the of the aerosol-generating article determined by the at least one sensor, the local humidity of the location of the aerosol-generating system and the a local temperature of the location of the aerosol-generating system.
Example Ex168. An aerosol-generating device according to any of examples Ex113 to Ex167, wherein the at least one sensor is configured to determine a classification of the aerosol-generating article when the aerosol-generating article is coupled to the aerosol-generating device.
Example Ex169. An aerosol-generating device according to example Ex168, wherein the at least one sensor comprises a classification sensor.
Example Ex170. An aerosol-generating device according to example Ex169, wherein the classification sensor is an optical sensor.
Example Ex171. An aerosol-generating device according to example Ex168 when dependent on example Ex126, wherein the classification of the aerosol-generating article when the aerosol-generating article is coupled to the aerosol-generating device is determined by the first acoustic receiver and the first acoustic emitter, or the first acoustic receiver and the second acoustic emitter.
Example Ex172. An aerosol-generating device according to example Ex168 when dependent on example Ex138, wherein the classification of the aerosol-generating article when the aerosol-generating article is coupled to the aerosol-generating device is determined by the first acoustic emitter and the first acoustic receiver, or the first acoustic emitter and the second acoustic receiver.
Example Ex173. An aerosol-generating device according to example Ex168 when dependent on example Ex134 and example Ex138, wherein the classification of the aerosol-generating article when the aerosol-generating article is coupled to the aerosol-generating device is determined by the first acoustic emitter and the first acoustic receiver, or the second acoustic emitter and the second acoustic receiver.
Example Ex174. An aerosol-generating device according to any of examples Ex168 to Ex173, wherein the controller is configured to control at least one function of the plurality of control functions of the aerosol-generating device based on the classification of the aerosol-generating article.
Example Ex175. An aerosol-generating device according to any of examples Ex168 to Ex174, wherein the controller is configured to control at least one function of the plurality of control functions of the aerosol-generating device based on a combination of the classification of the aerosol-generating article and the humidity of the aerosol-generating article.
Example Ex176. An aerosol-generating device according to any of examples Ex168 to Ex175, wherein the aerosol-generating device comprises a computer readable memory, and the controller is configured to determine the classification of the aerosol-generating article by comparing data from the at least one sensor to classification data stored in the readable computer memory.
Example Ex177. An aerosol-generating device according to example Ex176 when dependent on example Ex120, wherein the computer readable memory comprises a plurality of heating profiles, wherein each of the heating profiles of the plurality of heating profiles is associated with a classification of a plurality of classifications of the aerosol-generating article and a humidity range of a plurality of humidity ranges of the aerosol-generating article, wherein the controller is configured to select a selected heating profile from the plurality of heating profiles dependent on the humidity of the aerosol-generating article and the classification of the aerosol-generating article determined by the at least one sensor, and wherein the controller is configured control the supply of power supplied to the one or more heating elements based on the selected heating profile.
Example Ex178. An aerosol-generating device according to example Ex177 when dependent on example Ex162, wherein the controller is configured to select the selected heating profile from the plurality of heating profiles dependent on a combination of the local humidity of the location of the aerosol-generating system and the humidity of the aerosol-generating article, and the classification of the aerosol-generating article determined by the at least one sensor.
Example Ex179. An aerosol-generating device according to example Ex175 when dependent on example Ex162, wherein the controller is configured to control at least one function of the plurality of control functions of the aerosol-generating device based on a combination of the humidity of the of the aerosol-generating article determined by the at least one sensor, the local humidity of the location of the aerosol-generating system and the classification of the aerosol-generating article determined by the at least one sensor.
Example Ex180. An aerosol-generating device according to example Ex179 when dependent on example Ex165, wherein the controller is configured to control at least one function of the plurality of control functions of the aerosol-generating device based on a combination of the humidity of the of the aerosol-generating article determined by the at least one sensor, the local humidity of the location of the aerosol-generating system, the classification of the aerosol-generating article determined by the at least one sensor, and a local temperature of the location of the aerosol-generating system.
Example Ex180A. An aerosol-generating system comprising an aerosol-generating device according to any of Examples Ex133 to Ex180, and an aerosol-generating article.
Example Ex180B. An aerosol-generating system according to Example Ex180A wherein the aerosol-generating article comprises an aerosol-generating substrate comprising nicotine.
Example Ex181. A method of operation for an aerosol-generating system, the aerosol-generating system comprising an aerosol-generating device for generating aerosol from an aerosol-generating article, the aerosol-generating device configured to be coupled to the aerosol-generating article, the aerosol-generating device comprising a controller configured to control at least one function of a plurality of control functions of the aerosol-generating device, and the aerosol-generating device comprising at least one sensor for determining a humidity of the aerosol-generating article when the aerosol-generating article is coupled to the aerosol-generating device, the method comprising the steps of:
   determining a humidity of the aerosol-generating article when the aerosol-generating article is coupled to the aerosol-generating device, and
   controlling at least one function of the plurality of control functions of the aerosol-generating device based on the humidity of the aerosol-generating article.
Example Ex182. A method of operation for an aerosol-generating system according to example Ex181, wherein the aerosol-generating device comprises an acoustic sensor, and wherein the humidity of the aerosol-generating article is determined by acoustic sensing.
Example Ex183. A method of operation for an aerosol-generating system according to example Ex181 or Ex182, wherein the aerosol-generating device further comprises one or more heating elements, the one or more heating elements configured to heat the aerosol-generating article when the aerosol-generating article is coupled to the aerosol-generating device, and a power supply, the controller configured to control a supply of power from the power supply to the one or more heating elements.
Example Ex184. A method of operation for an aerosol-generating system according to example Ex183, wherein the at least one function of the plurality of control functions of the aerosol-generating device comprises controlling the supply of power supplied to the one or more heating elements.
Example Ex185. A method of operation for an aerosol-generating system according to example Ex183 or Ex184, wherein the at least one function of the plurality of control functions of the aerosol-generating device comprises controlling a heating profile of the one or more heating elements.
Example Ex186. A method of operation for an aerosol-generating system according to example Ex185, wherein the aerosol-generating device comprises a computer readable memory, and the method further comprises the step of selecting a heating profile stored in the readable computer memory based on the humidity of the aerosol-generating article.
Example Ex187. A method of operation for an aerosol-generating system according to any of examples Ex181 to Ex186, wherein the at least one function of the plurality of control functions of the aerosol-generating device comprises stopping the power supplied to the one or more heating elements.
Example Ex188. A method of operation for an aerosol-generating system according to any of examples Ex181 to Ex187, wherein the at least one function of the plurality of control functions of the aerosol-generating device comprises displaying a warning to a user.
Example Ex189. A method of operation for an aerosol-generating system according to any of examples Ex181 to Ex188, wherein the at least one function of the plurality of control functions of the aerosol-generating device comprises displaying a suggestion for at least one user setting of the aerosol-generating device to a user.
Example Ex190. A method of operation for an aerosol-generating system according to any of examples Ex181 to Ex189, the method further comprising the step of determining a classification of the aerosol-generating article when the aerosol-generating article is coupled to the aerosol-generating device.
Example Ex191. A method of operation for an aerosol-generating system according to example Ex190, the method further comprising the step of controlling at least one function of the plurality of control functions of the aerosol-generating device based on the classification of the aerosol-generating article.
Example Ex192. A method of operation for an aerosol-generating system according to example Ex190 or Ex191, the method further comprising the step of controlling at least one function of the plurality of control functions of the aerosol-generating device based on a combination of the classification and the humidity of the aerosol-generating article.
Example Ex193. A method of operation for an aerosol-generating system according to any of examples Ex190 to Ex192, wherein the aerosol-generating device comprises a computer readable memory, and wherein the step of determining a classification comprises comparing data from the at least one sensor to classification data stored in the readable computer memory.
Example Ex194. A method of operation for an aerosol-generating system according to any of examples Ex181 to Ex193, wherein the method further comprises the step of the aerosol-generating device determining the location of the aerosol-generating system or receiving data indicative of the location of the aerosol-generating system, and controlling at least one function of the plurality of control functions of the aerosol-generating device based on the location of the aerosol-generating system or data indicative of the location of the aerosol-generating system.
Example Ex195. A method of operation for an aerosol-generating system according to example Ex194, wherein the method further comprises the step of the aerosol-generating device communicating with an external computing device, and the external computing device sending data indicative of the location of the aerosol-generating system or the location of the aerosol-generating system to the aerosol-generating device.
Example Ex196. A method of operation for an aerosol-generating system according to example Ex194 or Ex195, wherein the step of the aerosol-generating device determining the location of the aerosol-generating system or receiving data indicative of the location of the aerosol-generating system further comprises the step of a user inputting the location of the aerosol-generating system.
Example Ex197. A method of operation for an aerosol-generating system according to any of examples Ex194 to Ex196, wherein the step of the aerosol-generating device determining the location of the aerosol-generating system or receiving data indicative of the location of the aerosol-generating system comprises using a global positioning system (GPS) chip.
Example Ex198. A method of operation for an aerosol-generating system according to example Ex197, wherein the step of the aerosol-generating device determining the location of the aerosol-generating system or receiving data indicative of the location of the aerosol-generating system comprises using data output from a global positioning system (GPS) chip.
Example Ex199. A method of operation for an aerosol-generating system according to any of examples Ex195 to Ex198, wherein the aerosol-generating system comprises a memory storing data indicative of the location of the aerosol-generating system, and wherein the step of the aerosol-generating device determining the location of the aerosol-generating system or receiving data indicative of the location of the aerosol-generating system comprises using the data indicative of the location of the aerosol-generating system.
Example Ex200. A method of operation for an aerosol-generating system according to example Ex199, wherein the data indicative of the location of the aerosol-generating system comprises an IP address of the external computing device.
Example Ex201. A method of operation for an aerosol-generating system according to any of examples Ex195 to Ex200, wherein the step of the aerosol-generating device determining the location of the aerosol-generating system or receiving data indicative of the location of the aerosol-generating system comprises using two or more of: GPS data, IP address data and/or data input by the user via a user interface.
Example Ex202. A method of operation for an aerosol-generating system according to any of examples Ex195 to Ex200, wherein the step of the aerosol-generating device determining the location of the aerosol-generating system or receiving data indicative of the location of the aerosol-generating system comprises using two or more of: GPS data, IP address data and/or data input by the user via a user interface.
Example Ex203. A method of operation for an aerosol-generating system according to example Ex202, wherein the step of the aerosol-generating device determining the location of the aerosol-generating system or receiving data indicative of the location of the aerosol-generating system comprises confirming that at least one of the GPS data, IP address data and/or data input by the user via a user interface matches at least one of the another of the GPS data, IP address data and/or data input by the user via a user interface.
Example Ex204. A method of operation for an aerosol-generating system according to any of examples Ex194 to Ex203, wherein the data indicative of the location of the aerosol-generating system comprises a local humidity of the location of the aerosol-generating system.
Example Ex205. A method of operation for an aerosol-generating system according to example Ex204, wherein the method further comprises the step of controlling at least one function of the plurality of control functions of the aerosol-generating device based on a combination of the humidity of the aerosol-generating article determined by the at least one sensor and the local humidity of the location of the aerosol-generating system.
Example Ex206. A method of operation for an aerosol-generating system according to example Ex205, wherein the method further comprises the step of controlling at least one function of the plurality of control functions of the aerosol-generating device after comparing the humidity of the of the aerosol-generating article determined by the at least one sensor to the local humidity of the location of the aerosol-generating system.
Example Ex207. A method of operation for an aerosol-generating system according to any of examples Ex194 to Ex206, wherein the data indicative of the location of the aerosol-generating system comprises a local temperature of the location of the aerosol-generating system.
Example Ex208. A method of operation for an aerosol-generating system according to example Ex207, wherein the method further comprises the step of controlling at least one function of the plurality of control functions of the aerosol-generating device based on a combination of the humidity of the aerosol-generating article determined by the at least one sensor and the local temperature of the location of the aerosol-generating system.
Example Ex209. A method of operation for an aerosol-generating system according to example Ex208 when dependent on example Ex204, wherein the method further comprises the step of controlling at least one function of the plurality of control functions of the aerosol-generating device based on a combination of the humidity of the of the aerosol-generating article determined by the at least one sensor, the local humidity of the location of the aerosol-generating system and the a local temperature of the location of the aerosol-generating system.
Example Ex210. A method of operation for an aerosol-generating system according to example Ex191 when dependent on example Ex186, wherein the computer readable memory comprises a plurality of heating profiles, wherein each of the plurality of heating profiles is associated with a classification of a plurality of classifications of the aerosol-generating article and a humidity range of a plurality of humidity ranges of the aerosol-generating article, wherein the method further comprising the step of selecting a selected heating profile from the plurality of heating profiles dependent on the humidity of the aerosol-generating article and the classification of the aerosol-generating article determined by the at least one sensor, and wherein the method further comprising the step of controlling the supply of power supplied to the one or more heating elements based on the selected heating profile.
Example Ex211. A method of operation for an aerosol-generating system according to example Ex210 when dependent on example Ex204, wherein the method further comprising the step of selecting a selected heating profile from the plurality of heating profiles dependent on a combination of the local humidity of the location of the aerosol-generating system and the humidity of the aerosol-generating article, and the classification of the aerosol-generating article determined by the at least one sensor
Example Ex212. A method of operation for an aerosol-generating system according to example Ex204 when dependent on example Ex191, wherein the method further comprising the step of controlling at least one function of the plurality of control functions of the aerosol-generating device based on a combination of the humidity of the of the aerosol-generating article determined by the at least one sensor, the local humidity of the location of the aerosol-generating system and the classification of the aerosol-generating article determined by the at least one sensor.
Example Ex213. A method of operation for an aerosol-generating system according to example Ex212 when dependent on example Ex207, wherein the method further comprising the step of controlling at least one function of the plurality of control functions of the aerosol-generating device based on a combination of the humidity of the of the aerosol-generating article determined by the at least one sensor, the local humidity of the location of the aerosol-generating system, the classification of the aerosol-generating article determined by the at least one sensor, and the a local temperature of the location of the aerosol-generating system.

Examples will now be further described with reference to the figures in which:

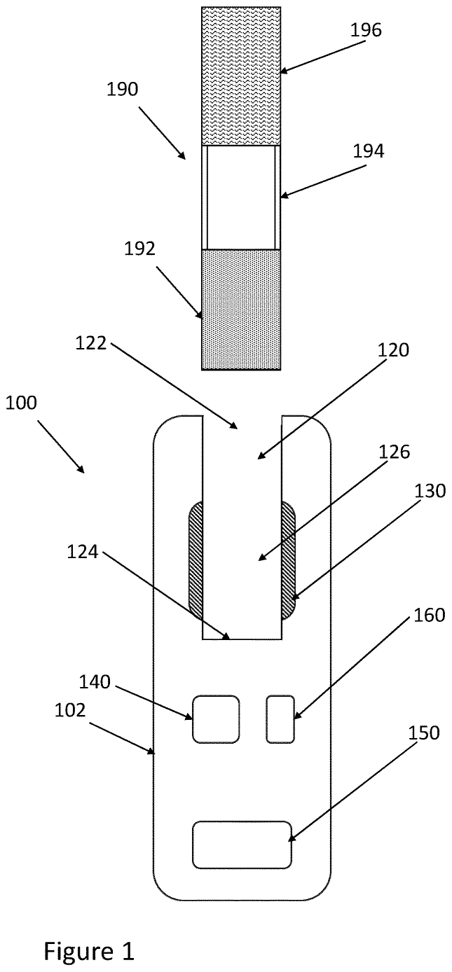

FIG. 1 shows an aerosol-generating device, and an example aerosol-generating article for coupling to the aerosol-generating device;

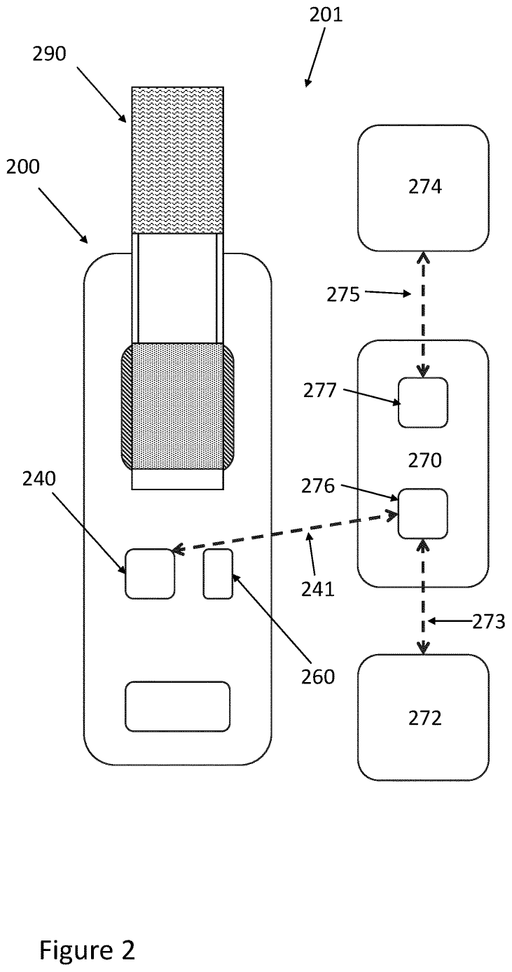

FIG. 2 shows an aerosol-generating system, the aerosol-generating system comprising the aerosol-generating device according to FIG. 1, the example aerosol-generating article coupled to the aerosol-generating device, and a personal computing device connected to the aerosol-generating device;

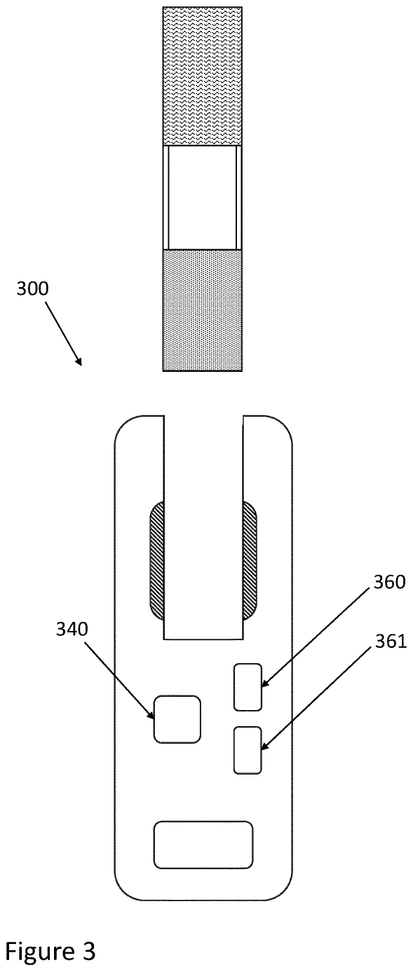

FIG. 3 shows another aerosol-generating device, the aerosol-generating device itself comprising a device location determining apparatus;

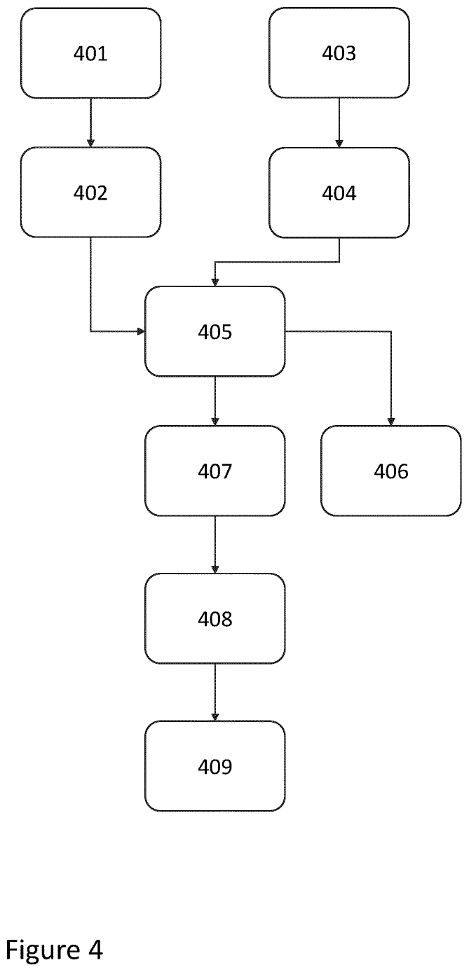

FIG. 4 shows a method of operating an aerosol-generating system shown in FIG. 2;

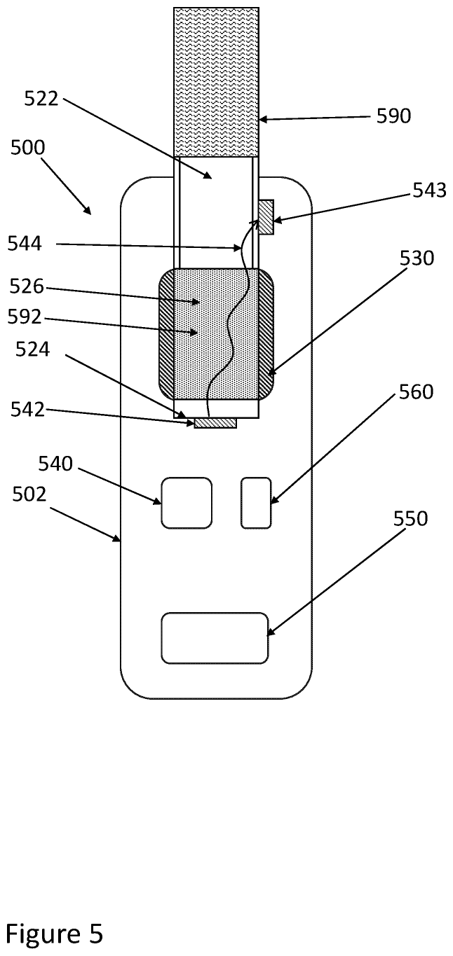

FIG. 5 shows another aerosol-generating device, and the example aerosol-generating article coupled to the aerosol-generating device, the aerosol-generating device comprising a first acoustic emitter and a first acoustic receiver;

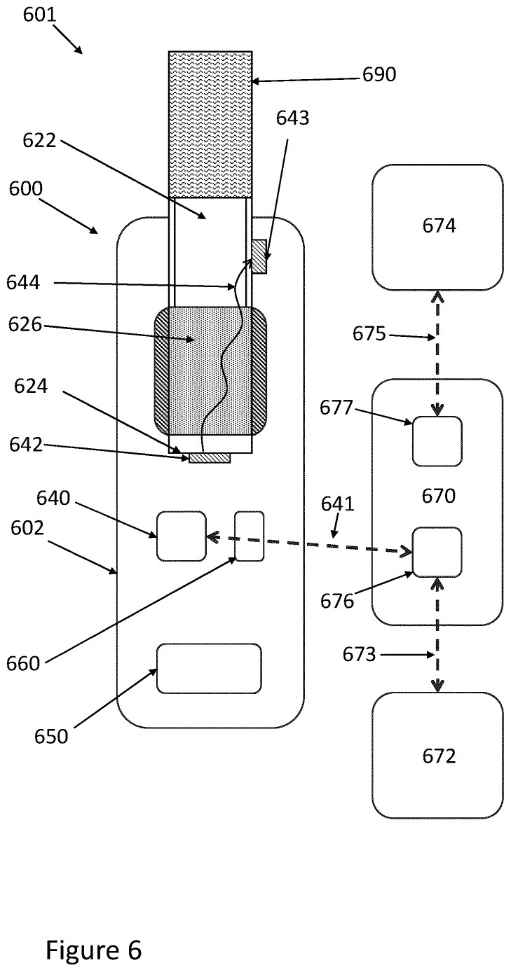

FIG. 6 shows another aerosol-generating system, the aerosol-generating system comprising the aerosol-generating device as shown in FIG. 5, the example aerosol-generating article coupled to the aerosol-generating device and a personal computing device connected to the aerosol-generating device;

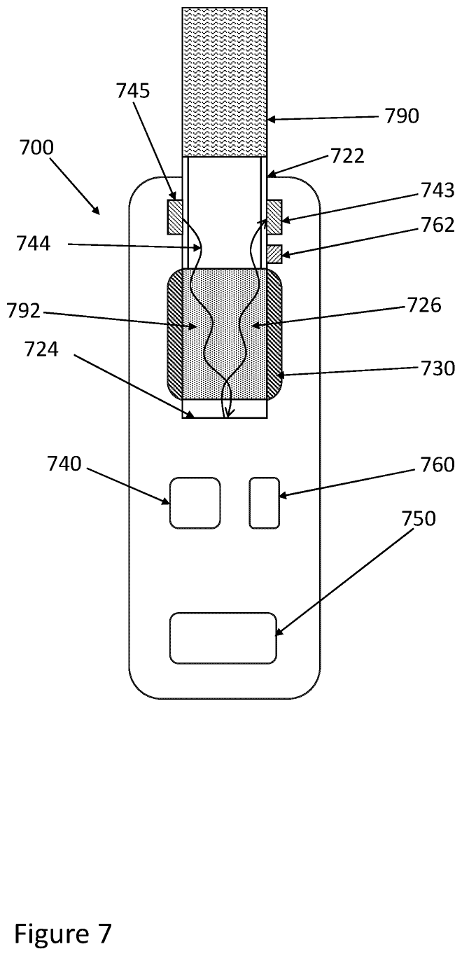

FIG. 7 shows another aerosol-generating device, the example aerosol-generating article coupled to the aerosol-generating device, and the aerosol-generating device comprising a first acoustic emitter and a first acoustic receiver, both of which are longitudinally positioned between the heating zone formed by the heater assembly, and the proximal end of the cavity;

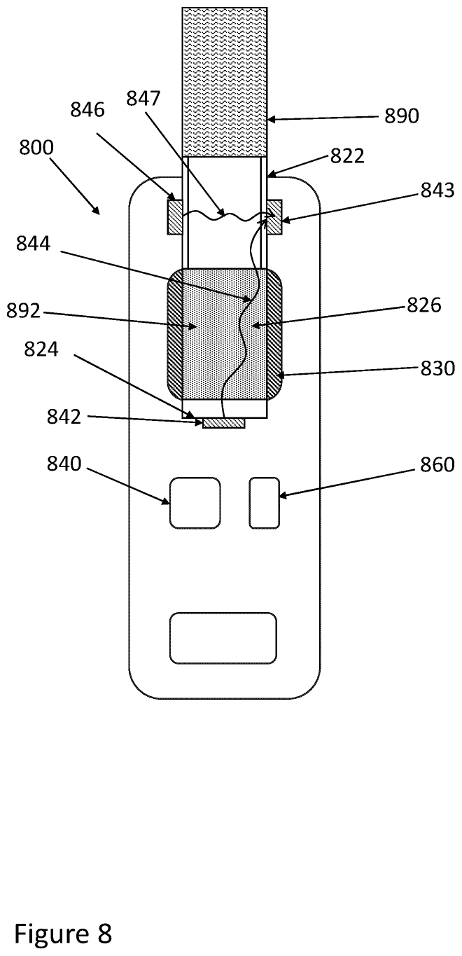

FIG. 8 shows another aerosol-generating device, the aerosol-generating device comprising a first and a second acoustic emitter and a first acoustic receiver; and

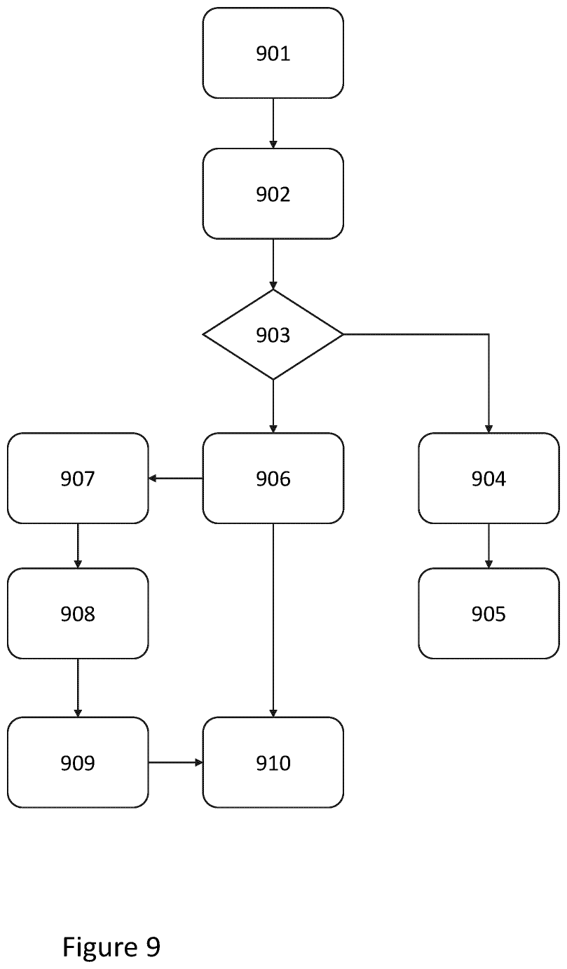

FIG. 9 shows a method of operating an aerosol-generating system as shown in FIG. 6.

FIG. 1 shows an aerosol-generating device 100. The aerosol-generating device 100 comprises an outer housing 102 which a user may hold when using the aerosol-generating device 100.

The aerosol-generating device 100 comprises a cavity 120 for receiving an aerosol-generating article 190. The cavity 120 has a distal end 124 and a proximal end 122, the cavity 120 meeting the outer housing 102 at the proximal end 122. A heater assembly 130 circumferentially surrounds a portion of the cavity 120. The portion of the cavity is positioned between the distal end 124 and the proximal end 122 of the cavity 120. The heater assembly 130 comprises a resistive heating element (not shown) configured to heat the portion of the cavity 120 which is circumferentially surrounded by the heater assembly 130. This portion of the cavity 120, which is heated by the heating element, is referred to as a heating zone 126.

The aerosol-generating device 100 comprises a controller 140. The controller is connected via electrical wiring to the heating element of the heater assembly 130. The controller is also connected via electrical wiring to a rechargeable power supply 150, and to a computer readable memory 160.

The controller 140 is configured to receive location data indicative of the location of the aerosol-generating device, or location-dependent data which is dependent on the location (or at least the estimated location) of the aerosol-generating device. In particular, the controller 140 is configured to receive location data (or location-dependent data) indicative of the location of the aerosol-generating device from an external computing device. This feature is described in more detail in FIG. 2. In FIG. 1, the controller 140 comprises a Bluetooth interface module, such that the location data is received by the controller 140 using the Bluetooth interface module. The skilled person would understand that an alternative communication module may be used instead of the Bluetooth interface module, for example a Wi-Fi interface module, or a wired USB interface module.

In FIG. 1, the location-dependent data that the controller 140 is configured to receive is firmware. The firmware is loaded onto the controller 140. The firmware comprises a plurality of control functions for controlling the aerosol-generating device 100, and one or more programs executable to perform the plurality of control functions are saved into the computer readable memory 160.

By loading the location-dependent firmware onto the controller, the controller 140 is configured to perform a plurality of control functions for controlling the aerosol-generating device 100 in manner that is tailored for its location.

A first set of the plurality control functions are heating profiles for controlling the power supplied by the rechargeable power supply 150 to the heating element of the heater assembly 130. The heating profiles are stored in the computer readable memory 160. The heating profiles vary one or both of the voltage, current or power supplied to the heating element from the rechargeable power supply 150 with respect to time. In FIG. 1, in response to a user action (e.g. in response to pressing a button, or another touch sensor on the device), the controller 140 performs one or more of the heating profiles by controlling one or both of the voltage or current supplied to the heating element from the rechargeable power supply 150. The firmware loaded onto the controller 140, which is selected dependent on the location, may include a heating profile for that location. That heating profile may be a default heating profile that may be executed in response to a user initiating a heating cycle.

The rechargeable power supply may be (re) charged via an external electrical connector (not shown) exposed through the outer housing 102. A second set of the plurality control functions are charging profiles for controlling the power supplied to the rechargeable power supply 150 during a recharging process. The charging profiles are stored in the computer readable memory 160. The charging profiles vary one or both of the voltage or current supplied to the rechargeable power supply 150 from the external electrical connector with respect to time. In FIG. 1, the controller 140 performs one or more of the charging profiles by controlling one or both of the voltage, current or power supplied to the rechargeable power supply 150 from the external electrical connector. The firmware loaded onto the controller 140, which is selected dependent on the location, may include a charging profile for that location. That charging profile may be a default charging profile that may be executed in response to the external electrical connector providing power to the rechargeable power supply 150.

A third set of the plurality control functions are age verification processes. The age verification processes are stored in the computer readable memory 160. The controller 140 is configured to control power supplied to the heating element dependent on whether a selected age verification process is met. The user may verify their age using an external computing device, described in more detail in FIG. 2, in communication with the controller 140. The firmware loaded onto the controller 140, which is selected dependent on the location, may include an age verification process for that location. That age verification process may be a default age verification process that may be executed in response to a request to unlock the device.

Various alternatives for the location data indicative of the location of the aerosol-generating device may be used however, which may be selected and utilised by the skilled person depending on the exact operation and functions performable by the controller 140. For example, instead of or in addition to the firmware, the location-dependent data may instead comprise one or more of a set of coordinates, a country name, code or number, a continent name, code or number, a region name, code or number, a temperature, a humidity, an age threshold, firmware or an IP address. In these cases, the plurality control functions could be predetermined control functions stored on the computer-readable memory 160, which could be selected by the controller 140 based on the location data indicative of the location of the aerosol-generating device received by the controller 140.

An aerosol-generating article 190 is shown uncoupled from the aerosol-generating device 100, and is an elongate cylindrical shape. The aerosol-generating article 190 comprises an aerosol-forming substrate 192 at a first end of the aerosol-generating article 190, and a filter component 196 at a second end of the aerosol-generating article 190 opposite to the first end. The aerosol-forming substrate 192 comprises a gathered sheet of homogenised tobacco material. However, other types of tobacco-containing substrate, such as a tobacco cut filler, can replace the gathered sheet of homogenised tobacco material. The filter component 196 comprises a low-density filtration material. The aerosol-generating article 190 comprises a hollow tubular component 194 positioned between the aerosol-forming substrate 192 and the filter component 196. The aerosol-generating article 190 is circumscribed by an outer wrapper (not shown).

Prior to use, the aerosol-generating article 190 is coupled to the aerosol-generating device 100 such that the aerosol-generating article 190 is partially received in the cavity 120. The aerosol-forming substrate 192 is aligned with the heater assembly 130.

During use, power is supplied to the heating element of the heater assembly 130, such that the aerosol-forming substrate 192 is heated to a temperature at which aerosol is formed from the aerosol-forming substrate 192. The user draws on the second end of the aerosol-generating article 190, drawing the generated aerosol through the aerosol-generating article 190 to the mouth of the user.

During use of the aerosol-generating device 100, the controller 140 selects at least one of the heating profiles and at least one of the age verification processes from the plurality of control functions for controlling the aerosol-generating device. During charging of the aerosol-generating device 100, the controller 140 selects at least one of the charging profiles from the plurality of control functions for controlling the aerosol-generating device. The heating profile, charging profile selected and/or age verification process is selected dependent on the location data received by the controller 140. For example, if the location data is indicative of a wet or humid location, the controller 140 selects a wet heating profile as opposed to a dry heating profile. Each heating profile comprises a heating element temperature profile and a duty cycle limit profile. The heating element temperature profiles are similar between wet and dry heating profiles, however the duty cycle limit profiles differ between wet and dry heating profiles to ensure that the heating element temperature profile is achieved regardless of the environmental conditions of the system. In addition or alternatively, a default heating profile, charging profile selected and/or age verification process of the firmware is used. Since the firmware loaded onto the controller 140 is based on the location of the aerosol-generating device, the device operates in a manner specific for its location.

FIG. 2 discloses an aerosol-generating system 201. The aerosol-generating system 101 comprises an aerosol-generating device 200 as shown in FIG. 1. The aerosol-forming article 290, as shown in FIG. 1, is shown as received in the cavity of the aerosol-generating device 200.

The aerosol-generating system 201 comprises a personal computing device 270, such as a smartphone. The personal computing device 270 comprises a personal computing device controller 276. The personal computing device controller 276 is in communication with the Bluetooth interface module of the controller 240 using a Bluetooth communication signal 241.

The personal computing device 270 further comprises a location determining apparatus 277. The location determining apparatus 277 is connected to the personal computing device controller 276 via electrical wiring. The location determining apparatus comprises a global positioning system (GPS), the GPS chip being in communication with a satellite system 274 via a satellite signals 275.

The location determining apparatus 277 determines the location of the personal computing device using data received from satellite system 274. Other methods of determining the location of the personal computing device may be used, for example using an IP address of the personal computing device, or a user manually inputting the location of the personal computing device using a user interface. As the personal computing device controller 276 is in communication with the Bluetooth interface module of the controller 240 using a relatively short range Bluetooth communication signal 241, the location of the personal computing device is considered to be the same as the location of the aerosol-generating device 200. This location can therefore be referred to as the location of the aerosol-generating system. The location determining apparatus 277 sends the location or data indicative of the location of the aerosol-generating system to the personal computing device controller 276 via electrical wiring.

The personal computing device controller 276 is also in communication with a remote server 272 via a remote server connection 273. The personal computing device controller 276 sends a request to the remote server 272 via a remote server connection 273 dependent on the location of the aerosol-generating system. The remote server 272 stores different firmware versions, each firmware version corresponding to a location or a range of locations. Following the request from the personal computing device controller 276, the remote server 272 sends firmware to the personal computing device controller 276 dependent on the location of the aerosol-generating system. The personal computing device controller 276 sends the firmware received from the server to the controller 240 via Bluetooth communication signal 241, where it is loaded onto the controller 240 as described above.

FIG. 3 shows an aerosol-generating device 300. The aerosol-generating device 300 is similar to the aerosol generating device 100, 200 disclosed in FIGS. 1 and 2, so will be described only with respect to its differences.

The aerosol-generating device 300 itself comprises a device location determining apparatus 361. The device location determining apparatus 361 is connected to the controller 340 via electrical wiring. The device location determining apparatus 361 comprises a global positioning system (GPS), the GPS chip being in communication with a satellite system via satellite signals. However, the skilled person would understand that alternative location determining apparatuses may be used to determine to location of the aerosol-generating device 300, as described above.

In comparison to that described with reference to FIGS. 1 and 2 the heating profiles, charging profiles, and age verification processes are predetermined, and are stored in the computer readable memory 360. During use, the device location determining apparatus 361 receives location data indicative of the location of the aerosol-generating device 300 from the GPS chip. The device location determining apparatus 361 then sends the location data indicative of the location of the aerosol-generating device 300 to the controller 340. Here, the device location determining apparatus 361 sends GPS coordinate data indicative of the location of the aerosol-generating device 300 to the controller 340. The controller selects at least one control function from the plurality of predetermined control functions stored on the computer readable memory 360 dependent on the GPS coordinate data indicative of the location of the aerosol-generating device 300. Again, various alternatives for the location data indicative of the location of the aerosol-generating device may be used, which may be selected and utilised by the skilled person depending on the exact operation and functions performable by the controller. For example, the location data may instead be one or more of a country name, code or number, a continent name, code or number, a region name, code or number, a temperature, a humidity or an age threshold. In these cases, the location determining apparatus may first compare the GPS coordinate data received from the GPS chip with data stored on the computer readable memory, the data correlating GPS coordinate data with one or more of a country name, code or number, a continent name, code or number, a region name, code or number, a temperature, a humidity or an age threshold.

FIG. 4 shows a method of operating an aerosol-generating system. The aerosol-generating system is the aerosol-generating system described with reference to FIG. 1.

The method comprises a first step 401 of the personal computing device determining a location of the aerosol-generating system using a GPS chip. Data indicative of location of the aerosol-generating system, determined using the GPS chip, is output to the personal computing device controller 402. Simultaneously, the external computing device determines a location of the aerosol-generating system using an alternative means 403, e.g. using an IP address of the external computing device. Again, data indicative of location of the aerosol-generating system, this time determined using the IP address, is output to the personal computing device controller 404.

Here, the data indicative of location of the aerosol-generating system determined using the GPS chip and the IP address output to the personal computing device controller are country codes. Various other data categories data indicative of location of the aerosol-generating system may be used instead of country code, including coordinates, a country name or number, a continent name, code or number, or a region name, code or number.

The method then comprises a step of comparing the data indicative of location of the aerosol-generating system, determined using the GPS chip to the data indicative of location of the aerosol-generating system, determined using the IP address 405. If the country code determined using the GPS chip does not match or is not sufficiently similar to the country code determined using the IP address, an error message is displayed to a user on the personal computing device 406.

If the country code determined using the GPS chip does match or is sufficiently similar to the country code determined using the IP address, the personal computing device controller sends a request to the remote server via an internet connection, the request dependent on the country code 407. The remote server then sends the personal computing device controller firmware via an internet connection 408, the firmware dependent on the request from the personal computing device controller. After receiving the firmware from the remote server, the personal computing device controller sends the firmware to the controller of the aerosol-generating device, where the firmware is loaded onto the controller of the aerosol-generating device 409.

FIG. 5 discloses an aerosol-generating device 500. The aerosol-generating device 500 is similar to the aerosol-generating devices described with reference to FIGS. 1 to 3, and so will be described with respect to its differences only.

The aerosol-forming article 590 is identical to the aerosol-forming article described with reference to FIGS. 1 and 2. The aerosol-forming article 590 is shown in FIG. 5 as received within the cavity of the aerosol-generating device 500.

The aerosol-generating device 500 comprises a first acoustic emitter 542, and a first acoustic receiver 543. The first acoustic emitter 542 and the first acoustic receiver 543 are both connected to the controller 540 via electrical wiring.

The first acoustic receiver 543 is positioned adjacent to the cavity of the aerosol-generating device 500, and a surface of the first acoustic receiver 543 forms part of an internal wall of the cavity. The first acoustic receiver 543 is longitudinally positioned between heating zone 526 formed by the heater assembly 530 and the proximal end 522 of the cavity.

The first acoustic emitter 542 is also positioned adjacent to the cavity of the aerosol-generating device 500, and a surface of the first acoustic emitter 542 forms part of an internal wall of the cavity. The first acoustic emitter 542 is positioned at the distal end 524 of the cavity.

The heating zone 526 formed by the heater assembly 130 is therefore located between the first acoustic emitter 542 and the first acoustic receiver 543.

The first acoustic emitter 542 is configured to generate and emit ultrasound waves with a plurality of frequencies. When the aerosol-forming article 590 is received within the cavity of the aerosol-generating device 500, the controller 540 sends an electrical signal to the first acoustic emitter 542, causing the first acoustic emitter 542 to generate and emit ultrasound waves with a plurality of frequencies. The ultrasound waves emitted by the first acoustic emitter 542 travel through the aerosol-forming article 590, to the first acoustic receiver 543. The first acoustic receiver 543 is configured to detect the ultrasound waves with the plurality of frequencies emitted by the first acoustic emitter 542. The first acoustic receiver 543 sends an electrical signal for each of the plurality of frequencies to the controller 540 indicative of the magnitude of the ultrasound waves received by the first acoustic receiver 543.

In particular, the ultrasound waves emitted by the first acoustic emitter 542 travel through the aerosol-forming substrate of the aerosol-forming article 590, to the first acoustic receiver 543.

The sound waves emitted by the first acoustic emitter 542 that are traveling through the aerosol-forming substrate are damped by it. The sound damping level is directly impacted by the density, elasticity and the humidity level of the fibrous substrate. For example the fibres get denser and heavier with increasing humidity and moisture content. Therefore, the humidity of the aerosol-forming substrate may be determined by analysing the magnitude of the ultrasound waves detected by the first acoustic receiver 543.

The controller 540 therefore computes the damping levels of the ultrasound waves for each of the plurality of frequencies received by the first acoustic receiver 543 which have travelled through the aerosol-forming substrate.

The computer readable memory 560 stores expected sound damping levels of the aerosol-forming substrates for different classifications of aerosol-forming article for each of the plurality of frequencies, and the expected sound damping levels of aerosol-forming substrates at various levels of humidity for each of the plurality of frequencies.

The controller 540 compares the calculated damping level for each of the plurality of frequencies to the stored damping levels, and from this comparison determines the classification and the humidity of the aerosol-forming article 590 received in the aerosol-generating device.

In a further example, the computer readable memory 560 may instead store expected sound damping levels of the aerosol-forming substrates for different classifications of aerosol-forming article for each of the plurality of frequencies. In this case, the humidity of the aerosol-forming substrate 592 of the aerosol-forming article 590 may be determined by the controller 540 using the deviation of the calculated damping level from the expected sound damping levels for the determined classification. For example, a greater damping than expected for a determined classification would indicate that the aerosol-forming substrate 592 of the aerosol-forming article 590 has a greater humidity.

The controller 540 controls the operation of the aerosol-generating device 500 dependent on the classification and the humidity of the aerosol-forming article 590. In particular, the controller 540 controls the power supplied to the heating element of the heater assembly 530 dependent on the classification and the humidity of the aerosol-forming article 590. The computer readable memory also stores a plurality of heating profiles. Each heating profile comprises at least one power value and an associated length of time. Each heating profile in the plurality of heating profiles is associated with a classification of aerosol-forming article and a range of humidity values. During use, the controller 540 selects a heating profile from the plurality of heating profiles dependent on the classification and the humidity of the aerosol-forming article 590, and controls the supply of power from the power supply 550 to the heating element of the heater assembly 530 in accordance with the selected heating profile.

FIG. 6 shows an aerosol-generating system 601. The aerosol-generating system 601 comprises an aerosol-generating device 600. The aerosol-generating device 600 is similar to the aerosol-generating device 500 described with respect to FIG. 5, and so will be described with regards to its differences only.

The aerosol-generating system 601 comprises a personal computing device 670, such as a smartphone. The personal computing device 670 comprises a personal computing device controller 676. The personal computing device controller 676 is in communication with the Bluetooth interface module of the controller 640 using a Bluetooth communication signal 641.

The personal computing device 670 further comprises a location determining apparatus 677. The location determining apparatus 677 is connected to the personal computing device controller 676 via electrical wiring. The location determining apparatus comprises a global positioning system (GPS), the GPS chip being in communication with a satellite system 674 via a satellite signals 675.

The location determining apparatus 677 determines the location of the personal computing device using data received from satellite system 674. Other methods of determining the location of the personal computing device may be used, for example using an IP address of the personal computing device, or a user manually inputting the location of the personal computing device using a user interface. As the personal computing device controller 676 is in communication with the Bluetooth interface module of the controller 640 using a relatively short range Bluetooth communication signal 641, the location of the personal computing device is considered to be the same as the location of the aerosol-generating device 600. This location can therefore be referred to as the location of the aerosol-generating system. The location determining apparatus 677 sends the location or data indicative of the location of the aerosol-generating system to the personal computing device controller 676 via electrical wiring.

The personal computing device controller 676 is also in communication with a remote server 676 via a remote server connection 673. The personal computing device controller 676 sends a request to the remote server 672 via a remote server connection 673 dependent on the location of the aerosol-generating system. The remote server 672 comprises data such as local temperature and local humidity, each corresponding to a location or a range of locations. Following the request from the personal computing device controller 676, the remote server 672 sends the local temperature and the local humidity to the personal computing device controller 676 dependent on the location of the aerosol-generating system. The personal computing device controller 676 sends the local temperature and the local humidity received from the server to the controller 640 via Bluetooth communication signal 641.

The controller 640 controls the operation of the aerosol-generating device 600 dependent on the classification and the humidity of the aerosol-forming article 690, and the data indicative of the location of the aerosol-generating device 600 received from the personal computing device 670. In particular, the controller 640 controls the power supplied to the heating element of the heater assembly 630 dependent on the classification and the humidity of the aerosol-forming article 590, and the local temperature and local humidity of the location of the aerosol-generating device 600.

The computer readable memory 660 comprises data correlating the local humidity of the location of the aerosol-generating device 600 with an expected humidity of the aerosol-forming article 690. The controller 640 compares the local humidity of the location of the aerosol-generating device 600 to the data to determine an expected humidity of the aerosol-forming article 690. The controller 640 compares the calculated humidity of the aerosol-forming article 690 to the expected humidity of the aerosol-forming article 690. If the calculated humidity is significantly different to the expected humidity, the controller 640 will issue a warning to a user, for example by activating a warning light on the aerosol-generating device (not shown). In some examples, the data correlating the local humidity of the location of the aerosol-generating device 600 with an expected humidity of the aerosol-forming article 690 may instead be stored on the remote server 672, which is accessed by the personal computing device controller 676.

The computer readable memory 660 also stores a plurality of heating profiles. Each heating profile in the plurality of heating profiles is associated with a classification of aerosol-forming article, a range of humidity values, and a range of temperature values. During use, the controller 640 selects a heating profile from the plurality of heating profiles dependent on the classification, the humidity of the aerosol-forming article 690, and the local temperature, and controls the supply of power from the power supply 650 to the heating element of the heater assembly 630 in accordance with the selected heating profile.

FIG. 7 shows an aerosol-generating device 700. The aerosol-generating device 700 is similar to the aerosol-generating device 500 described with reference to FIG. 5, and so will be described primarily with respect to its differences.

The aerosol-generating device 700 comprises a first acoustic emitter 745, and a first acoustic receiver 743. The first acoustic emitter 745 and the first acoustic receiver 743 are both connected to the controller 740 via electrical wiring.

The first acoustic receiver 743 is positioned adjacent to the cavity of the aerosol-generating device 700, and a surface of the first acoustic receiver 743 forms part of an internal wall of the cavity. The first acoustic receiver 743 is longitudinally positioned between the heating zone formed by the heater assembly 730 and the proximal end 722 of the cavity.

The first acoustic emitter 745 is also positioned adjacent to the cavity of the aerosol-generating device 700, and a surface of the first acoustic emitter 742 forms part of an internal wall of the cavity. In contrast to the aerosol-generating device described with reference to FIG. 3, the first acoustic emitter 742 is also longitudinally positioned between the heating zone formed by the heater assembly 730 and the proximal end 722 of the cavity. The first acoustic emitter 745 and the first acoustic receiver 743 are positioned on opposite sides of the cavity to one another. The heating zone 726 formed by the heater assembly 730 is therefore not located between the first acoustic emitter 745 and the first acoustic receiver 743.

The first acoustic emitter 745 is configured to generate and emit ultrasound waves with a single frequency. When the aerosol-forming article 790 is received within the cavity of the aerosol-generating device 700, the controller 740 sends an electrical signal to the first acoustic emitter 745, causing the first acoustic emitter 745 to generate and emit ultrasound waves with a single frequency. The ultrasound waves emitted by the first acoustic emitter 745 travel through the aerosol-forming article 790, in particular through the aerosol-forming substrate 792, to the distal end of the cavity 724. The ultrasound waves are reflected off a surface forming the distal end of the cavity 724, and travel back through the aerosol-forming substrate 792 to the first acoustic receiver 743.

The first acoustic receiver 743 is configured to detect the ultrasound waves with the single frequency emitted by the first acoustic emitter 745 and reflected off the surface of the distal end of the cavity. The first acoustic receiver 743 sends an electrical signal to the controller 740 indicative of the magnitude of the ultrasound waves received by the first acoustic receiver 743.

The aerosol-generating device 700 further comprises an optical classification sensor 762. The optical classification sensor 762 is positioned adjacent to the cavity of the aerosol-generating device 700, and a surface of the optical classification sensor 762 forms part of an internal wall of the cavity. When the aerosol-forming article 790 is received in the cavity, the optical classification sensor 762 scans a classification indication, such as a QR code or a bar code, printed onto the outer surface of the aerosol-forming article 790. The optical classification sensor 762 sends data indicative of the classification indication to the controller 740. The controller 740 determines the classification of the aerosol-forming article 790 by comparing the data indicative of the classification indication to a database stored on the computer readable memory 760. This database comprises a plurality of classifications, each classification associated with data indicative of a classification indication.

The controller 740 controls the operation of the aerosol-generating device 700 dependent on the classification of the aerosol-forming article 790 and the humidity of the aerosol-forming article 790 as described in relation FIG. 3.

FIG. 8 shows an aerosol-generating device 800. aerosol-generating device 800 is similar to the aerosol-generating device 500 described with reference to FIG. 5, and so will be described with primarily respect to its differences.

The aerosol-generating device 800 comprises a first comprises a first acoustic emitter 842, a second acoustic emitter 846, and a first acoustic receiver 843. The first acoustic emitter 842 second acoustic emitter 846, and the first acoustic receiver 843 are all connected to the controller 840 via electrical wiring.

The first acoustic receiver 843 is positioned adjacent to the cavity of the aerosol-generating device 800, and a surface of the first acoustic receiver 843 forms part of an internal wall of the cavity. The first acoustic receiver 843 is longitudinally positioned between the heating zone formed by the heater assembly 830 and the proximal end 822 of the cavity.

The first acoustic emitter 842 is also positioned adjacent to the cavity of the aerosol-generating device 800, and a surface of the first acoustic emitter 842 forms part of an internal wall of the cavity. The first acoustic emitter 842 is positioned at the distal end 824 of the cavity.

The heating zone 826 formed by the heater assembly 830 is therefore located between the first acoustic emitter 842 and the first acoustic receiver 843.

The second acoustic emitter 846 is also positioned adjacent to the cavity of the aerosol-generating device 800, and a surface of the second acoustic emitter 846 forms part of an internal wall of the cavity. The second acoustic emitter 846 is also longitudinally positioned between the heating zone formed by the heater assembly 830 and the proximal end 822 of the cavity. The second acoustic emitter 846 and the first acoustic receiver 843 are positioned on opposite sides of the cavity to one another. The heating zone 826 formed by the heater assembly 830 is therefore not located between the second acoustic emitter 845 and the first acoustic receiver 843.

The first acoustic emitter 842 and the second acoustic emitter 846 are configured to generate and emit ultrasound waves with a plurality of frequencies. When the aerosol-forming article 890 is received within the cavity of the aerosol-generating device 800, the controller 840 sends an electrical signal to the first acoustic emitter 842, causing the first acoustic emitter 842 and the second acoustic emitter 846 to generate and emit ultrasound waves with a plurality of frequencies. The ultrasound waves emitted by the first acoustic emitter 842 and the second acoustic emitter 846 travel through the aerosol-forming article 890, to the first acoustic receiver 843. The first acoustic receiver 843 is configured to receive the ultrasound waves with the plurality of frequencies emitted by the first acoustic emitter 842 and the second acoustic emitter 846. The first acoustic receiver 843 sends an electrical signal for each of the plurality of frequencies to the controller 840 indicative of the ultrasound waves received by the first acoustic receiver 843.

In particular, the ultrasound waves 844 emitted by the first acoustic emitter 842 travel through the aerosol-forming substrate 892 of the aerosol-forming article 890, to the first acoustic receiver 843. Therefore, the humidity the aerosol-forming substrate 892 may be analysed.

The ultrasound waves 847 emitted by the second acoustic emitter 846 travel through the aerosol-forming article 890. In particular the ultrasound waves 847 do not travel through the aerosol-forming substrate 892 to the first acoustic emitter 843, an instead travel through a hollow acetate tube portion of the aerosol-forming article 890.

The damping experience by the ultrasound waves 847 emitted by the second acoustic emitter 846 is therefore different to the damping experienced by the ultrasound waves 844 emitted by the first acoustic emitter 842.

The electrical signals received by the controller 840 from the first acoustic receiver 843 indicative of ultrasound waves 847 emitted by the second acoustic emitter 846 are used to determine the classification of the aerosol-forming article 890. Different aerosol-forming articles result in different amounts of damping of the ultrasound waves 847 emitted by the second acoustic emitter 846, as for example the thickness of the hollow acetate tube portion may vary between classifications. The controller 840 calculates and then compares the damping levels of the ultrasound waves 847 emitted by the second acoustic emitter 846 to damping values stored in the computer readable memory 860 to determine the classification of the aerosol-forming article 890.

The electrical signals received by the controller 840 from the first acoustic receiver 843 indicative of ultrasound waves 844 emitted by the first acoustic emitter 842 are then used to determine the humidity of the aerosol-forming article 890, in particular the aerosol-forming substrate 892. The computer readable memory 860 also stores expected sound damping levels of aerosol-forming substrates at various levels of humidity for different classifications of aerosol-forming article for each of the plurality of frequencies.

The controller 840 compares the calculated damping level of the ultrasound waves 844 emitted by the second acoustic emitter 842 for each of the plurality of frequencies to the stored damping levels, and from this comparison determines the humidity of the aerosol-forming article 890 received in the aerosol-generating device.

FIG. 9 shows a method of operating an aerosol-generating system. The aerosol-generating system is the aerosol-generating system described with reference to FIG. 6. The method comprises a first step 901 of an aerosol-forming article being coupled to an aerosol-generating device by the user. The method comprises the step of determining the classification of the aerosol-forming article coupled to the aerosol-generating device, as described in detail with regards to FIGS. 5 to 8. The method then comprises the step of determining if the classification of the aerosol-forming article is of a known classification 903. If the classification of the aerosol-forming article is not of a known classification, such that the computer readable memory does not have a damping value associated with a known classification for the damping value calculated by the controller, the aerosol-generating system determines that the aerosol-forming article is not a suitable aerosol-forming article for aerosol generation 904. In this event, the aerosol-generating system then stops power from being supplied from the rechargeable power supply, and displays a warning to the user, for example a visual indication via an LED on the aerosol-generating device.

If the classification of the aerosol-forming article is of a known classification, the humidity of the aerosol-forming article is then determined by the controller using the at least one acoustic emitter and the at least one acoustic receiver 906, as described in detail with regards to FIGS. 5 to 8. The classification and the humidity of the aerosol-forming article

The aerosol-generating system additionally determines the location of the aerosol-generating system using the GPS chip of the personal computing device 907, as described with regards to FIG. 6.

The personal computing device retrieves data dependent on the location of the aerosol-generating system from the server 908, in this example the local temperature and the local humidity of the location of the aerosol-generating system. The personal computing device then the local temperature and the local humidity received from the server to the controller via the Bluetooth communication signal 909.

The controller the controls the operation of the aerosol-generating device dependent on the classification and the humidity of the aerosol-forming article, and the data indicative of the location of the aerosol-generating device received from the personal computing device 910. The exact operation of this control is described in detail with regards to FIG. 6.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A±10% of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-15. (canceled)

16. An aerosol-generating device for generating aerosol from an aerosol-generating article, the aerosol-generating device comprising:
at least one sensor configured to determine a humidity of the aerosol-generating article; and
a controller configured to control at least one function of a plurality of control functions of the aerosol-generating device based on the humidity of the aerosol-generating article determined by the at least one sensor,
wherein the at least one sensor comprises at least one acoustic sensor.

17. The aerosol-generating device according to claim 16, further comprising:
one or more heating elements configured to heat the aerosol-generating article; and
a power supply, the controller being further configured to control a supply of power from the power supply to the one or more heating elements.

18. The aerosol-generating device according to claim 16,
wherein the aerosol-generating device is couplable to an aerosol-generating article comprising one or more heating elements, and
wherein the aerosol-generating device further comprises a power supply, the controller being further configured to control a supply of power from the power supply to the one or more heating elements.

19. The aerosol-generating device according to claim 18, further comprising a cavity configured to receive the aerosol-generating article.

20. The aerosol-generating device according to claim 19, wherein the at least one sensor is further configured to determine the humidity of the aerosol-generating article when the aerosol-generating article is received in the cavity.

21. The aerosol-generating device according to claim 17, wherein the at least one function of the plurality of control functions of the aerosol-generating device comprises controlling the supply of power supplied to the one or more heating elements.

22. The aerosol-generating device according to claim 17, wherein the at least one function of the plurality of control functions of the aerosol-generating device comprises controlling a heating profile of the one or more heating elements.

23. The aerosol-generating device according to claim 22,
further comprising a computer readable memory,
wherein the controller is further configured to select a heating profile stored in the computer readable memory based on the humidity of the aerosol-generating article.

24. The aerosol-generating device according to claim 16, wherein the at least one acoustic sensor comprises at least one acoustic emitter configured to emit sound waves with at least one frequency and at least one acoustic receiver configured to receive the sound waves with the at least one frequency.

25. The aerosol-generating device according to claim 16, wherein the aerosol-generating device is configured to determine a location of the aerosol-generating device or receive data indicative of a location of the aerosol-generating device.

26. The aerosol-generating device according to claim 25, wherein the controller is further configured to control at least one function of the plurality of control functions of the aerosol-generating device based on the location of the aerosol-generating device or the data indicative of the location of the aerosol-generating device.

27. The aerosol-generating device according to claim 16, wherein the at least one sensor is further configured to determine a classification of the aerosol-generating article when the aerosol-generating article is coupled to the aerosol-generating device.

28. An aerosol-generating system comprising an aerosol-generating device according to claim 16, and an aerosol-generating article.

29. A method of operating an aerosol-generating system,
the aerosol-generating system comprising an aerosol-generating device configured to generate aerosol from an aerosol-generating article, the aerosol-generating device being further configured to be coupled to the aerosol-generating article, the aerosol-generating device comprising a controller configured to control at least one function of a plurality of control functions of the aerosol-generating device, and the aerosol-generating device comprising at least one sensor configured to determine a humidity of the aerosol-generating article when the aerosol-generating article is coupled to the aerosol-generating device, the at least one sensor comprising at least one acoustic sensor,
the method comprising the steps of:
determining the humidity of the aerosol-generating article when the aerosol-generating article is coupled to the aerosol-generating device; and
controlling at least one function of the plurality of control functions of the aerosol-generating device based on the humidity of the aerosol-generating article.
